(19) United States
(12) Patent Application Publication
(10) Pub. No.: US 2025/0240409 A1
(43) Pub. Date: Jul. 24, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Lei ZHAO, Beijing (CN); Kai ZHANG, Los Angeles, CA (US); Li ZHANG, Los Angeles, CA (US)

(21) Appl. No.: 19/173,577

(22) Filed: Apr. 8, 2025

Related U.S. Application Data
(63) Continuation of application No. PCT/CN2023/123409, filed on Oct. 8, 2023.

(30) Foreign Application Priority Data
Oct. 8, 2022 (WO) PCT/CN2022/123877

(51) Int. Cl. H04N 19/105; H04N 19/176; H04N 19/192

(52) U.S. Cl. CPC H04N 19/105; H04N 19/176; H04N 19/192

(57) ABSTRACT

Embodiments of the present disclosure provide a solution for video processing. A method for video processing is proposed. The method comprises: determining, for a conversion between a current video block of a video and a bitstream of the video, a plurality of motion vector prediction (MVP) candidates of the current video block; determining a candidate list of the current video block by applying a plurality of pruning processes to the plurality of MVP candidates; and performing the conversion based on the candidate list.

### CROSS REFERENCE TO RELATED APPLICATIONS

This application is a continuation of International Application No. PCT/CN2023/123409, filed on Oct. 8, 2023, which claims the benefit of International Application No. PCT/CN2022/123877 filed on Oct. 8, 2022. The entire contents of these applications are hereby incorporated by reference in their entireties.

### FIELDS

Embodiments of the present disclosure relates generally to video processing techniques, and more particularly, to motion candidate list construction.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, a plurality of motion vector prediction (MVP) candidates of the current video block; determining a candidate list of the current video block by applying a plurality of pruning processes to the plurality of MVP candidates; and performing the conversion based on the candidate list. The method in accordance with the first aspect of the present disclosure determines the candidate list of the current video block by applying a plurality of pruning processes, and thus can avoid redundant candidate in the candidate list and improve the diversity of the candidate list. In this way, the coding efficiency and coding effectiveness can be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a plurality of motion vector prediction (MVP) candidates of a current video block of the video; determining a candidate list of the current video block by applying a plurality of pruning processes to the plurality of MVP candidates; and generating the bitstream based on the candidate list.

In a fifth aspect, a method for storing a bitstream of a video is proposed. The method comprises: determining a plurality of motion vector prediction (MVP) candidates of a current video block of the video; determining a candidate list of the current video block by applying a plurality of pruning processes to the plurality of MVP candidates; generating the bitstream based on the candidate list; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates positions of spatial and temporal neighboring blocks used in advanced motion vector prediction (AMVP) or merge candidate list constructure;

FIG. 5 illustrates an example diagram showing positions of non-adjacent candidate in ECM;

FIG. 6 illustrates an example diagram showing template matching performs on a search area around initial MV;

FIG. 7 illustrates an example diagram showing a template and the corresponding reference template;

FIG. 8 illustrates an example diagram showing template and reference template for block with sub-block motion using the motion information of the subblocks of current block;

FIG. 9 illustrates an example diagram showing an example of the positions for non-adjacent temporal motion vector prediction (TMVP) candidates;

FIG. 10 illustrates an example diagram showing an example of the template;

FIG. 11 illustrates a flowchart of a method for video processing in accordance with embodiments of the present disclosure; and

FIG. 12 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

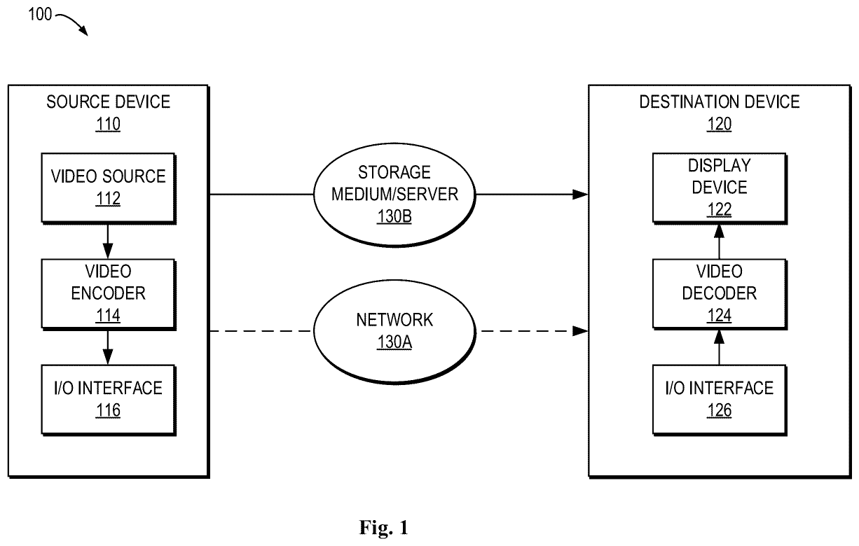

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

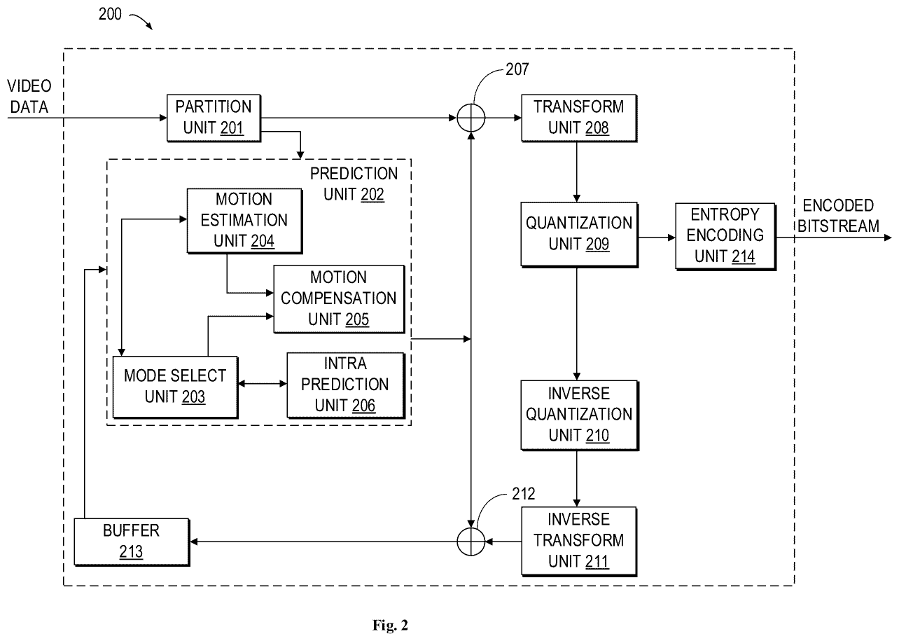

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

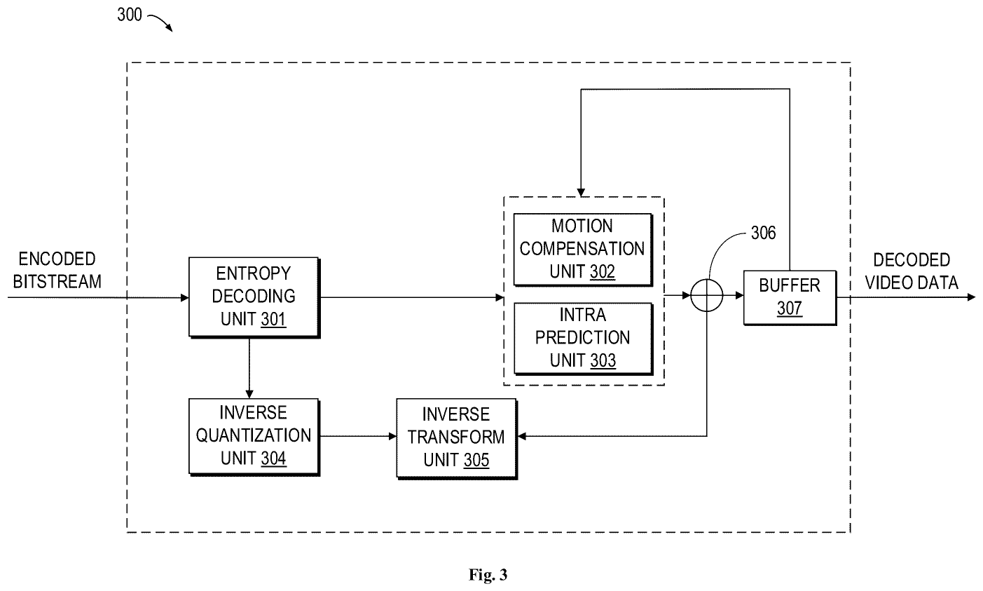

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to video coding technologies. Specifically, it is about motion vector prediction (MVP) construction method in video coding. The ideas may be applied individually or in various combination, to any video coding standard or non-standard video codec.

### 2. INTRODUCTION

The exponential increasing of multimedia data poses a critical challenge for video coding. To satisfy the increasing demands for more efficient compression technology, ITU-T and ISO/IEC have developed a series of video coding standards in the past decades. In particular, the ITU-T produced H.261 and H.263, ISO/IEC produced MPEG-1 and MPEG-4 visual, and the two organizations jointly developed the H.262/MPEG-2 Video, H.264/MPEG-4 Advanced Video Coding (AVC), H.265/HEVC and the latest VVC standards. Since H.262/MPEG-2, hybrid video coding framework is employed wherein in intra/inter prediction plus transform coding are utilized.

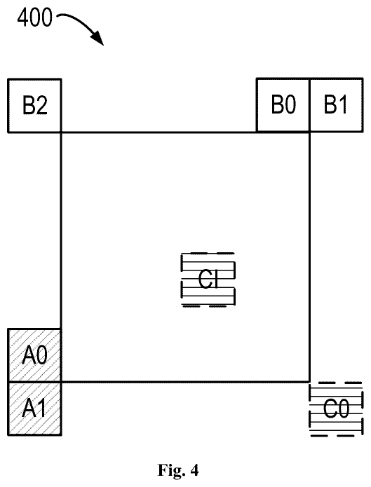

FIG. 4 illustrates a diagram 400 showing positions of spatial and temporal neighboring blocks used in AMVP/merge candidate list construction.

### 2.1. MVP in Video Coding

Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC, competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, an MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.

AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. For spatial motion vector candidate derivation, two motion vector candidates are eventually derived based on motion vectors of blocks located in five different positions as depicted in FIG. 4. The five neighboring blocks located at B0, B1, B2, and A0, A1 are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different co-located positions (bottom-right (C0) and central (C1)) checked in order, as depicted in FIG. 4. To avoid redundant MV candidates, duplicated motion vector candidates in the list are abandoned. If the number of potential candidates is smaller than two, additional zero motion vector candidates are added to the list.

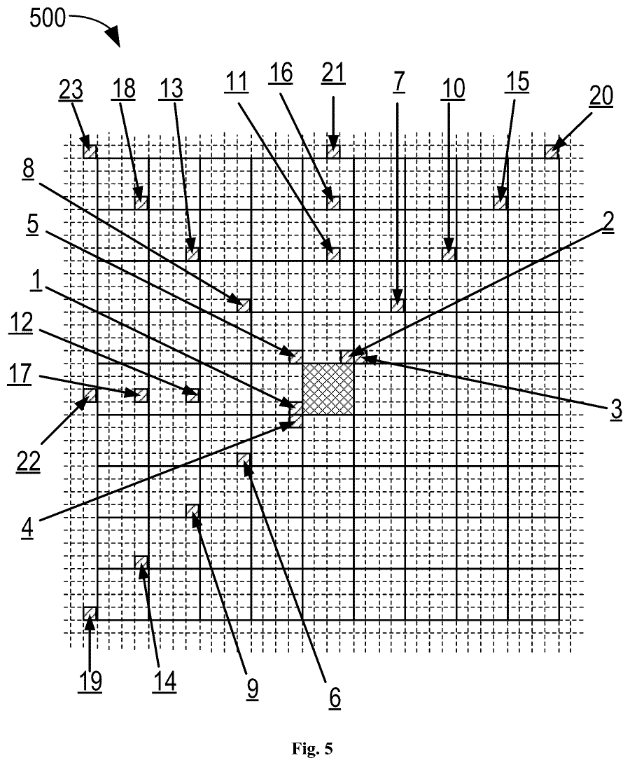

FIG. 5 illustrates a diagram 500 of positions of non-adjacent candidate in ECM.

Merge mode: Similar to AMVP mode, MVP candidate list for merge mode comprises of spatial and temporal candidates as well. For spatial motion vector candidate derivation, at most four candidates are selected with order A1, B1, B0, A0 and B2 after performing availability and redundant checking. For temporal merge candidate (TMVP) derivation, at most one candidate is selected from two temporal neighboring blocks (C0 and C1). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.

In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP. In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.

During the standardization of VVC, Non-adjacent MVP was proposed to facilitate better motion information derivation by exploiting the non-adjacent area. In ECM software, Non-adjacent MVP are inserted between TMVP and HMVP, where the distances between non-adjacent spatial candidates and current coding block are based on the width and height of current coding block as depicted in FIG. 5.

### 2.2. Interpolation Filters in VVC

In VVC, interpolations filters are used in both intra and inter coding process. Intra coding takes advantage of interpolation filters to generate fractional positions in angular prediction modes. In HEVC, a two-tap linear interpolation filter has been used to generate the intra prediction block in the directional prediction modes (i.e., excluding Planar and DC predictors). While in VVC, four-tap intra interpolation filters are utilized to improve the angular intra prediction accuracy. In particular, two sets of 4-tap interpolation filters are utilized in VVC intra coding, which are DCT-based interpolation filter (DCTIF) and smoothing interpolation filter (SIF). The DCTIF is constructed in the same way as the one used for chroma component motion compensation in both HEVC and VVC. The SIF is obtained by convolving the 2-tap linear interpolation filter with [1 2 1]/4 filter.

In VVC, the highest precision of explicitly signaled motion vectors is quarter-luma-sample. In some inter prediction modes such as the affine mode, motion vectors are derived at 1/16th-luma-sample precision and motion compensated prediction is performed at 1/16th-sample-precision. VVC allows different MVD precision ranging from 1/16-luma-sample to 4-luma-sample. For half-luma-sample precision, 6-tap interpolation filter is used. While for other fractional precisions, default 8-tap filter is used. Besides, the bilinear interpolation filter is used to generate the fractional samples for the searching process of decoder side motion vector refinement (DMVR) in VVC.

### 2.3. Template Matching Merge/A.VVP Mode in ECM

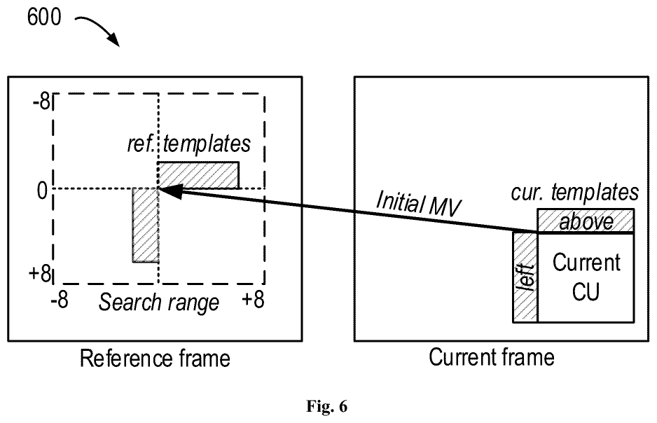

Template matching (TM) merge/AMVP mode is a decoder-side MV derivation method to refine the motion information of the current CU by finding the closest match between a template (i.e., top and/or left neighboring blocks of the current CU) in the current picture and a block (i.e., same size to the template) in a reference picture. As illustrated in FIG. 6, a better MV is to be searched around the initial motion of the current CU within a [−8, +8]-pel search range.

FIG. 6 illustrates a diagram 600 of template matching performs on a search area around initial MV.

In AMVP mode, an MVP candidate is determined based on the template matching error to pick up the one which reaches the minimum difference between the current block and the reference block templates, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode. This search process ensures that the MVP candidate still keeps the same MV precision as indicated by adaptive motion vector resolution (AMVR) mode after TM process.

In the merge mode, similar search method is applied to the merge candidate indicated by the merge index. TM merge may perform all the way down to 1/8-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check. When BM and TM are both enabled for a CU, the search process of TM stops at half-pel MVD precision and the resulted MVs are further refined by using the same model-based MVD derivation method as in DMVR.

### 2.4. Adaptive Reorder of Merge Candidates (ARMC)

Inspired by the spatial correlation between reconstructed neighboring pixels and the current coding block, adaptive reorder of merge candidates (ARMC) was proposed to refine the candidates order in a given candidate list. The underlying assumption is that the candidates with less template matching cost have higher probability to be chosen through RDO process, hence should be placed in front positions within the list to reduce the signaling cost.

The reordering method is applied to regular merge mode, template matching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5. Merge candidates in each subgroup are reordered ascendingly according to cost values based on template matching. For simplification, merge candidates in the last but not the first subgroup are not reordered.

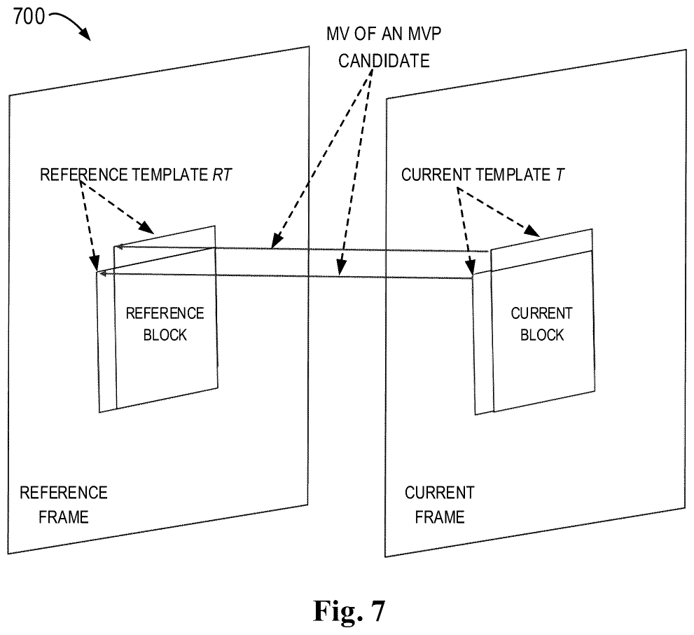

The template matching cost is measured by the sum of absolute differences (SAD) between samples of a template of the current block and their corresponding reference template. The template comprises a set of reconstructed samples neighboring to the current block, while reference template is located by the same motion information of the current block, as illustrated in FIG. 7. When a merge candidate utilizes bi-directional prediction, the reference samples of the template of the merge candidate are also generated by bi-prediction.

FIG. 7 illustrates a diagram 700 of template and the corresponding reference template.

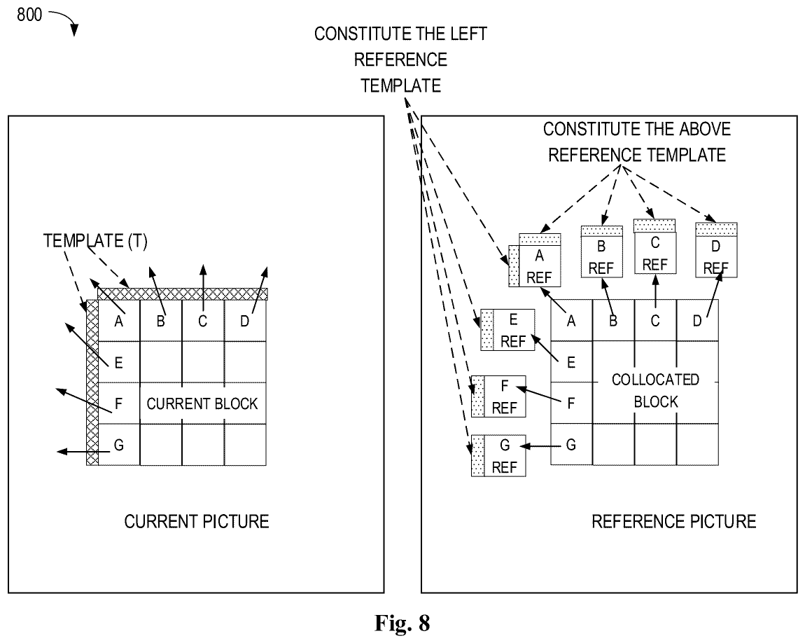

FIG. 8 illustrates a diagram 800 of template and reference template for block with sub-block motion using the motion information of the subblocks of current block.

For subblock-based merge candidates with subblock size equal to Wsub*Hsub, the above template comprises several sub-templates with the size of Wsub×1, and the left template comprises several sub-templates with the size of 1×Hsub. As shown in FIG. 8. the motion information of the subblocks in the first row and the first column of current block is used to derive the reference samples of each sub-template.

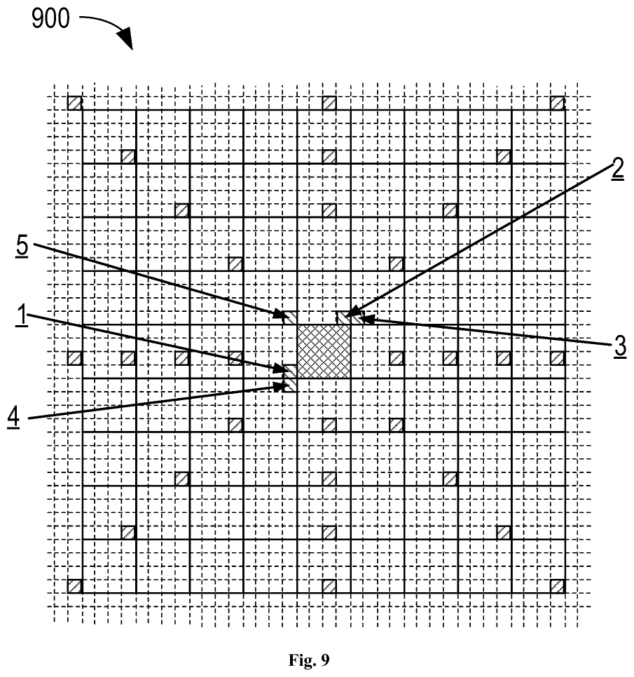

FIG. 9 illustrates an example diagram 900 of the positions for non-adjacent TMVP candidates.

### 2.5. Enhanced MVP Candidate Derivation (EMCD)

EMCD based on template matching cost reordering has been proposed. Instead of constructing the MVP list based on a predefined traversing order, we investigate an optimized MVP selecting approach by taking advantage of the matching cost in the reconstructed template region, such that more appropriate candidates are included in the list.

It should be noted that the proposed strategy for MVP list construction can be utilized in normal merge and AMVP list construction process and can also be easily extended to other modules that require MVP derivation, e.g., merge with motion vector difference (MMVD), Affine motion compensation, Subblock-based temporal motion vector prediction (SbTMVP) and so on.

### Non-Adjacent TMVP

1. It is proposed to make use of the TMVP in a non-adjacent area to further improve the effectiveness of the MVP list.
a) In one example, a non-adjacent area may be any block (such as 4×4 block) in a reference picture and neither inside nor adjacent to the collocated block in the reference picture of the current block.
b) In one example, the positions of the non-adjacent TMVP candidates are illustrated in FIG. 9, where black blocks represent the potential non-adjacent TMVP positions. It should be noted that this figure only provides an example for non-adjacent TMVP, and the positions are not limited to the indicated blocks. In other cases, non-adjacent TMVP may locate in any other positions in one or more reconstructed frames.

2. The maximum allowed non-adjacent TMVP number in the MVP list may be signaled in the bitstream.
a) In one example, the maximum allowed number can be signaled in SPS or PPS.

3. The non-adjacent TMVP candidates may locate in the nearest reconstructed frame, but it may also locate in other reconstructed frames.
a) Alternatively, non-adjacent TMVP candidates may locate in the collocated picture.
b) Alternatively, it is signaled in which picture non-adjacent TMVP candidates may locate.

4. Non-adjacent TMVP candidates may locate in multiple reference pictures.

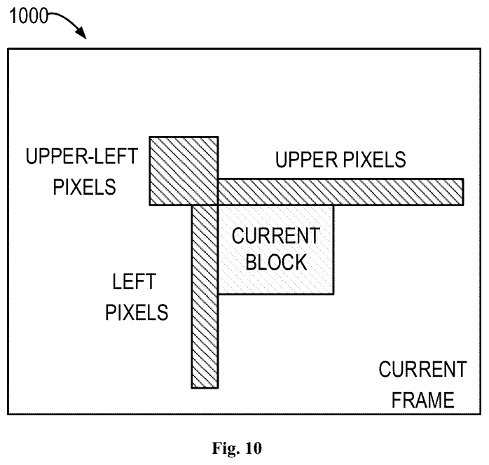

FIG. 10 illustrates an example diagram 1000 of the template.

5. The distances between a non-adjacent area associated with a TMVP candidate and current coding block may be related to the property of the current block.
a) In one example, the distances depend on the width and height of current coding block.
b) In other cases, the distances may be signaled in the bitstream as a constant.

### Definition of the Template

6. Template represents the reconstructed region that can be used to estimate the priority of an MVP candidate, which may locate in different positions with variable shape.
a) In one example, a template may comprise of the reconstructed regions in three positions, which are upper pixels, left pixels and upper-left pixels, as presented in FIG. 10.
b) It should be noted that the template may not necessarily be in rectangular shape, it can be in arbitrary shape, e.g., triangle or polygon.
c) In one example, the template regions may be utilized either in separate or combined manner.
d) A template may only comprise samples from one component such as luma, or from multiple components such as luma and chroma.

7. The template may not necessarily locate in the current frame, it may locate in any other reconstructed frame.

8. In one example, a reference template region with the same shape as the template of the current block may be located with an MV, as shown in FIG. 7.

9. In one example, the template may not necessarily locate in adjacent area, it may locate in non-adjacent areas that are far away from the current block.

10. In one example, a template may not necessarily contain all the pixels in a certain region, it may contain part of the pixels in a region.

### Template Matching Based MVP Candidate Ordering

11. In this disclosure, template matching cost associated with a certain MVP candidate serves as a measurement to evaluate the consistency of this candidate and true motion information. Based on this measurement, a more efficient order is generated by sorting the priority of each MVP candidate.
a) In one example, the template matching cost C is evaluated with mean of square error (MSE), as calculated below:

$$C = \frac{{\sum }_{( i , j ) ∈ T} {( T ( i , j ) - RT ( i , j ) )}^{2}}{N} ,$$

where T represents the template region, RT represents the corresponding reference template region specified by the MV within MVP candidate (FIG. 7), N is the pixel number within the template.
b) In one example, the template matching cost can be evaluated with sum of square error (SSE), sum of absolute difference (SAD), sum of absolute transformed difference (SATD) or any other criterion that can measure the difference between two regions.

12. All the MVP candidates are sorted in an ascending order regarding the corresponding template matching cost, and the MVP list is constructed by traversing the candidates in the sorted order until the MVP amount reaches the maximum allowed number. In this way, a candidate with a lower matching cost has a higher priority to be included in the ultimate MVP list.
a) In one example, the sorting process may be conducted towards all the MVP candidates.
b) Alternatively, this process may also be applied to part of candidates, e.g., non-adjacent MVP candidates, HMVP candidates or any other group of candidates.
c) Alternatively, furthermore, which categories of MVP candidates (e.g., non-adjacent MVP candidates are belonging to one category, HMVP candidates are belonging to another category) and/or what kinds of group of candidates should be reordered may be dependent on the decoded information, e.g., block dimension/coding methods (e.g., CIIP/MMVD) and/or how many available MVP candidates before being reordered for a given kind/group.
   1. In one example, the sorting process may be conducted for a joint group which contains only one category of MVP candidates.
   2. In one example, the sorting process may be conducted for a joint group which contains more than one category of MVP candidates.
      a) In one example, for a first coding method (e.g., regular/CIIP/MMVD/GPM/TPM/subblock merge mode), the sorting process can be conducted for a joint group of non-adjacent MVP, non-adjacent TMVP and HMVP candidates. For a second coding method (e.g., the template matching merge mode), the sorting process can be conducted for a joint group of adjacent MVP, non-adjacent TMVP, non-adjacent MVP and HMVP candidates.
      b) Alternatively, for a first coding method (e.g., regular/CIIP/MMVD/GPM/TPM/subblock merge mode), the sorting process can be conducted for a joint group of non-adjacent MVP and HMVP candidates. For a second coding method (e.g., the template matching merge mode), the sorting process can be conducted for a joint group of adjacent MVP, non-adjacent MVP and HMVP candidates.
   3. In one example, the sorting process may be conducted for a joint group which contains partial of available MVP candidates within the categories.
      a) In one example, for regular/CIIP/MMVD/TM/GPM/TPM/subblock merge mode, or for regular/affine AMVP mode, the sorting process can be conducted for a joint group of all or partial candidates from one or multiple categories.
   4. In above examples, the category may be
      i. adjacent neighboring MVPs:
      ii. adjacent neighboring MVPs at specific location(s):
      iii. TMVP MVPs:
      iv. HMVP MVPs:
      v. Non-adjacent MVPs:
      vi. Constructed MVPs (such as pairwise MVPs):
      vii. Inherited affine MV candidates:
      viii. Constructed affine MV candidates:
      ix. SbTMVP candidates.
d) In one example, this process may be conducted multiple times on different set of candidates.
   1. For example, a set of candidates (such as non-adjacent MVP candidates) may be sorted, and the N non-adjacent MVP candidates with the lowest costs may be put into the candidate list. After the whole candidate list is constructed, the costs of candidates in the list may be calculated and the candidates may be reordered based on the costs.

13. It is proposed that the MVP list construction process may involve both reordering of a single group/category and a joint group which contains candidates from more than one category.
a) In one example, the joint group may include candidates from a first and a second category.
   1. Alternatively, furthermore, the first and second category may be defined as the non-adjacent MVP category and HMVP category.
   2. Alternatively, furthermore, the first and second category may be defined as the non-adjacent MVP category and HMVP category, and the joint group may include candidates from a third category, e.g., TMVP category.
b) In one example, the single group may include candidates from a fourth category.
   1. Alternatively, furthermore, the fourth category may be defined as the adjacent MVP category.

14. Multiple groups or categories can be respectively reordered to construct MVP list.
a) In one example, only one single group (all the candidates belong to one category, e.g. adjacent MVP, non-adjacent MVP, HMVP, etc.) is built and reordered in MVP list construction process.
b) In one example, only one joint group (contains partial or all the candidates from multiple categories) is built and reordered in MVP list construction process.
c) In one example, more than one group (regardless of single or joint) are respectively built and reordered in MVP list construction process.
   1. In one example, two or more single groups are respectively built and reordered in MVP list construction process.
   2. In one example, two or more joint groups are respectively built and reordered in MVP list construction process.
   3. In one example, one or multiple single groups and one or multiple joint groups are respectively reordered in MVP list construction process.
      a) In one example, one single groups and one joint groups are respectively built and reordered to construct MVP list.
      b) In one example, one single groups and multiple joint groups are respectively built and reordered to construct MVP list.
      c) In one example, multiple single groups and one joint groups are respectively built and reordered to construct MVP list.
      d) In one example, multiple single groups and multiple joint groups are respectively built and reordered to construct MVP list.
d) In one example, candidates that belong to the same category can be divided into different groups, and are respectively reordered in the corresponding groups.
e) In one example, only partial candidates in specific category are put into the single or joint group, and rest candidates in this category are not reordered.
f) In above examples, the category may be
   1. adjacent neighboring MVPs;
   2. adjacent neighboring MVPs at specific location(s):
   3. TMVP MVPs;
   4. HMVP MVPs:
   5. Non-adjacent MVPs;
   6. Constructed MVPs (such as pairwise MVPs);
   7. Inherited affine MV candidates;
   8. Constructed affine MV candidates;
   9. SbTMVP candidates.

15. The proposed sorting method can also be applied to AMVP mode.
a) In one example, the MVP in AMVP mode can be extended with non-adjacent MVP, non-adjacent TMVP and HMVP.
b) In one example, MVP list for AMVP mode comprises K candidates, which are selected from M categories, such as adjacent MVPs, non-adjacent MVPs, non-adjacent TMVPs and HMVPs wherein K and M are integers.
   1. In one example, K could be smaller than M, or equal to M or greater than M.
   2. In one example, one candidate is selected from each category.
   3. Alternatively, for a given category, no candidate is selected.
   4. Alternatively, for a given category, more than 1 candidate is selected.
   5. In one example, MVP list for AMVP mode comprises 4 candidates, which are selected from adjacent MVPs, non-adjacent MVPs, non-adjacent TMVPs and HMVPs.
   6. In one example, each category of MVP candidates is respectively sorted with template matching cost, and the one with minimum cost in the corresponding category is selected and included in the MVP list.
   7. Alternatively, adjacent MVP candidates and a joint group of non-adjacent MVP, non-adjacent TMVP together with HMVP candidates are respectively sorted with template matching cost. One adjacent candidate with the minimum template matching cost is selected from adjacent MVP candidates, and three other candidates are derived by traversing the candidates in the joint group in an ascending order of template matching cost.
   8. In one example, MVP list for AMVP mode comprises 2 candidates, one comes from adjacent MVP and the other comes from non-adjacent MVP, non-adjacent TMVP or HMVP. In particular, adjacent MVP candidates and a joint group of non-adjacent MVP, non-adjacent TMVP together with HMVP are respectively sorted with template matching cost, and the one with minimum cost in the corresponding category (or group) is included in the MVP list.

16. The proposed sorting methods may be applied to other coding methods, e.g., for constructing a block vector list of IBC coded blocks.
a) In one example, it may be used for affine coded blocks.
b) Alternatively, furthermore, how to define the template cost may be dependent on the coding methods.

17. The usage of this method may be controlled with different coding level syntax, including but not limit to one or multiple of PU, CU, CTU, slice, picture, sequence levels.

18. On how to insert sorted candidates to MVP list.
a) In one example, which candidates within the joint or separate group are included into MVP list depends on the sorting results of template matching cost.
b) In one example, whether put the candidates within the separate or joint group into MVP list depends on the sorting results of template matching cost.
c) In one example, how many candidates within the separate or joint group are included into MVP list depends on the sorting results of template matching cost.
   1. In one example, only one candidate with the smallest template matching cost is included into MVP list.
   2. In one group, top-N candidates regarding the template matching cost in an ascending order are included into MVP list, where N is the maximum allowed candidate number can be inserted into MVP list in the corresponding single or joint group.
      a) In one example, N can be a predefined constant for each single or joint group.
      b) Alternatively, N can be adaptively derived based on the template matching cost within the single or joint group.
      c) Alternatively, N can be signaled in the bitstream.
      d) In one example, different candidate groups share a same N value.
      e) Alternatively, different single or joint groups may have different N value.

### Pruning for MVP Candidates

19. The pruning for MVP candidates aims to increase the diversity within the MVP list, which can be realized by using appropriate threshold TH.
a) In one example, if the two candidates point to same reference frame, they may both be included to MVP list only if the absolute difference between the corresponding X and Y components are either or both larger (or no smaller) than TH.

20. The pruning threshold can be signaled in the bitstream.
b) In one example, the pruning threshold can be signaled either in PU, CU, CTU or slice level.

21. The pruning threshold may depend on the characteristics of the current block.
c) In one example, the threshold may be derived by analyzing the diversity among the candidates.
d) In one example, the optimal threshold can be derived through RDO.

22. The pruning for MVP candidates may be firstly performed within a single or joint group before being sorted.
a) Alternatively, furthermore, for two MVP candidates belonging to two different groups or one belonging to a joint group and the other doesn't, pruning among these two MVP candidates are not performed before sorting.
b) Alternatively, furthermore, pruning among multiple groups may be applied after the sorting.

23. The pruning for MVP candidates may be firstly performed among multiple groups and the sorting may be further applied to one or multiple single/joint groups.
a) Alternatively, an MVP list may be firstly constructed with pruning among available MVP candidates involved. Afterwards, sorting may be further applied to reorder one or multiple single/joint groups.
b) Alternatively, furthermore, for two MVP candidates belonging to two different groups or one belonging to a joint group and the other doesn't, pruning among these two MVP candidates is performed before sorting.
   Interaction with Other Coding Tools

24. After an MVP list with above sorting methods applied, the Adaptive Reordering Merge Candidates (ARMC) process may be further applied.
a) In one example, the template costs used in the sorting process during MVP list construction may be further utilized in the ARMC.
b) In another example, different template costs may be used in the sorting process and ARMC process.
   1. In one example, the template may be different for the sorting and ARMC process.

25. Whether to and/how to enable the sorting process may be dependent on the coding tool.
a) In one example, when a certain tool (e.g., MMVD or affine mode) is enabled for a block, the sorting is disabled.
b) In one example, for two different tools, the sorting rules may be different (e.g., being applied to different groups or different template settings).

### 2.6. Simplifications for Template Matching Based Video Coding Methods

The template matching based video coding methods is optimized in two aspects. Firstly, reference template derivation process is revised that the interpolation process in the prediction block generation process is replaced by different ways. Secondly, several fast strategies are devised to speedup the tools related to template matching.

It should be noted that the proposed methods can be utilized in ARMC, EMCD and template matching MV refinement, and can also be easily extended to other potential utilizations that require template matching process, e.g., template matching based candidates reorder for merge with motion vector difference (MMVD), Affine motion compensation, Subblock-based temporal motion vector prediction (SbTMVP) and so on. In yet another example, the proposed methods could be applied to other coding tools that requires motion information refinement processes, e.g., bilateral matching-based coding tools.

The detailed embodiments below should be considered as examples to explain general concepts. These embodiments should not be interpreted in a narrow way. Furthermore, these embodiments can be combined in any manner. Combination between this patent application and others are also applicable.

1. It is proposed to replace the interpolation filtering process involved in the motion compensation process of an inter prediction signal generation process by other ways in the reference template generation process.
a) It is proposed to exclude interpolation filtering process to generate a reference template even the motion vector point to fractional positions.
   i. In one example, it is proposed to use an integer precision to generate a reference template.
   ii. In one example, if a motion vector points to a fractional position, it is rounded to be an integer MV firstly.
      1. In one example, the fractional position is rounded toward zero (that is, a negative motion vector predictor is rounded toward positive infinity and a positive motion vector predictor is rounded toward negative infinity).
      2. In one example, the round step may larger than 1.
b) It is proposed to use a different interpolation filter to generate reference templates for motion vectors pointing to fractional positions.
   i. In one example, a simplified interpolation filter may be applied.
      1. In one example, the simplified interpolation filter can be 2-tap bilinear, alternatively, it can also be 4-tap, 6-tap or 8-tap filter that belongs to DCT, DST, Lanczos or any other interpolation types.
   ii. In one example, a more complex interpolation filter (e.g., with longer filter taps) may be applied.
c) The above methods may be used to reorder the merge candidates for template matching merge mode.
   i. In one example, integer precision can be used in ARMC, EMCD, LIC and any other potential scenarios.
   ii. The above methods may be used to reorder the candidates for regular merge mode.
      1. In one example, integer precision can be used to reorder the candidates for regular merge mode.
d) In one example, whether to use above methods (e.g., integer precision, different interpolation filters) or not and/or how to use above methods can be signaled in the bitstream or determined on-the-fly according to decoded information.
   i. In one example, which method to be applied may be dependent on the coding tool.
   ii. In one example, which method to be applied may be dependent on block dimension.
   iii. In one example, integer precision may be used for a given color component (e.g., luma only).
   iv. Alternatively, integer precision may be used all of the three components.

2. Whether to and/or how to perform EMCD may be based on the maximum allowed candidate number within candidate list and/or available candidate number before being added to a candidate list.
a) In one example, assuming the number of available candidates (valid candidates that can be used to build candidate list) is NAVAL, and the maximum allowed candidate number is NMAX (that is, at most NMAX candidates can be included into the ultimate merge list), then EMCD is enabled only when NAVAL-NMAX larger than a constant or adaptively derived threshold T.

3. It is proposed to organize the available merge candidates into subgroups.
a) In one example, the available candidates can be categorized into subgroups, each subgroup contains a fixed or adaptively derived number of candidates, and each subgroup selects a fix number of candidates into the list. In the decoder side, only the candidates within a chosen subgroup need to be reordered.
b) In one example, the candidates can be categorized into subgroups according to the candidates' category, such as non-adjacent MVP, temporal MVP (TMVP) or HMVP, etc.

4. It is proposed that a piece of information calculated by a first coding tool utilizing at least one template cost may be reused by a second coding tool utilizing at least one template cost.
a) It is proposed to build a unified storage shared by ARMC, EMCD and any other potential tools to store the information of each merge candidate.
b) In one example, this storage can be a map, table or other data structure.
c) In one example, the stored information can be template matching cost.
d) In one example, EMCD first traverses all the MVs associated with the available candidates and store the corresponding information (including but not limited to template matching cost) in this storage. Then ARMC and/or other potential tools can simply access the needed information from this shared storage without performing repeating calculation.

### 2.7. Extensions of Motion Vector Prediction List Construction Based on Template Matching Cost Ordering

An optimized MVP list derivation method based on template matching cost ordering is proposed. Instead of constructing the MVP list based on a predefined traversing order, we investigate an optimized MVP selecting approach by taking advantage of the matching cost in the reconstructed template region, such that more appropriate candidates are included in the list.

It should be noted that the proposed strategy for MVP list construction can be utilized in normal merge and AMVP list construction process and can also be easily extended to other modules that require MVP derivation, e.g., merge with motion vector difference (MMVD), Affine motion compensation, Subblock-based temporal motion vector prediction (SbTMVP) and so on.

In the following discussion, category represents the belongingness of an MVP candidate, e.g., non-adjacent MVP candidates belong to one category; HMVP candidates belonging to another category. A group denotes an MVP candidate set which contains one or multiple MVP candidates. In one example, a single group denotes an MVP candidate set in which all the candidates belong to one category, e.g., adjacent MVP, non-adjacent MVP, HMVP, etc. In another example, a joint group denotes an MVP candidate set which contains candidates from multiple categories.

The detailed embodiments below should be considered as examples to explain general concepts. These embodiments should not be interpreted in a narrow way. Furthermore, these embodiments can be combined in any manner. Combination between this patent application and others are also applicable.

5. Multiple thresholds to determine whether a candidate could be added to a candidate list may be utilized in the candidate pruning process.
a) A threshold may be used to determine whether a potential candidate can be put into a candidate list.
   i. For example, if the absolute difference of at least one component of the MV of the potential candidate and that of a candidate existing in the candidate list is smaller than a threshold, the potential candidate is not put into the list.
   ii. For example, if the absolute difference of all components of the MV of the potential candidate and that of a candidate existing in the candidate list is smaller than a threshold, the potential candidate is not put into the list.
b) In one example, the candidate is an MVP candidate, the candidate pruning process is the MVP candidate pruning process, and the candidate list is a motion candidates list.
   i. In one example, the motion candidate list is a merge candidate list.
   ii. In one example, the motion candidate list is an AMVP candidate list.
   iii. In one example, the motion candidate list is an extend merge or AMVP list, such as sub-block merge candidate list, affine merge candidate list, MMVD list, GPM list, template matching merge list, biliteral matching merge list etc.
c) In one example, the pruning thresholds may be different for two groups, where the group can be either a single group (containing only one category of candidates) or a joint group (containing at least two categories of candidates).
d) Alternatively, only one threshold is used for all potential MVP candidates regardless of category and/or groups.
e) In one example, N (e.g., N=2) thresholds are used in the pruning process.
   i. Assume A is the MVP set which contains all available MVP candidates regardless of category, in one example, a first threshold is used for a first subset of candidates in set A, and a second threshold is used for a second subset of candidates (e.g., the rest candidates excluding those in the first subset) in set A.
   ii. In one example, a first threshold is used for a single group denoted by A, and a second threshold is used for another group (single or joint)/multiple other groups/rest of candidates which are not with the same category as those in A.
      1. In one example, a first threshold is used for the single group of adjacent candidates, and a second threshold is used for the rest candidates, including but not limited to non-adjacent MVP, HMVP, pairwise MVP and zero MVP.
   iii. The first threshold may be larger than or smaller than the second threshold.
f) Alternatively, furthermore, the threshold for an MVP category or group may be dependent on the decoded information, e.g., block dimension/coding methods (e.g., CIIP/MMVD) and/or the variance of motion information within the category or group.

6. Multi-pass reordering can be performed to construct an MVP list.
a) In one example, the multi-pass may involve different reordering criteria.
b) In one example, multi-pass reordering can be performed to multiple single/joint groups, wherein at least two single/joint groups may have overlap MVP candidates or not.
c) In one example, K-pass (e.g., K=2) reordering is used to construct an MVP list.
   i. In one example, in the first pass, a single/joint group A is firstly reordered based on a first cost (e.g., template matching cost) sorting, and the candidate with the largest cost (CL) in A is identified and then transferred to another single/joint group B (e.g. B may comprise the rest of candidates which are not with the same category as those in A). Subsequently, group B conduct the 2 to K pass reorder based on the first cost (or other cost metrics) sorting. Finally, the candidates in group A (except CL) and B (CL included) are included in the MVP list in accordance with the sorted order.
   ii. In one example, the group A in above case is a single group of adjacent candidates, and group B is a joint group of non-adjacent candidates and HMVP.
   iii. Alternatively, group A and B may be any other single or joint candidate group.
   iv. In one example, in the first pass, one or multiple single/joint groups are firstly reordered based on a first cost (e.g., template matching cost) sorting. Then a preliminary MVP list is constructed by inserting some of the candidates in each group into the list with the sorted order. Subsequently, the preliminary MVP list performs the second pass reorder to select partial candidates into the ultimate MVP list.
      1. In one example, different single/joint groups may have overlap candidates or not.
      2. In one example, all of the candidates in the preliminary MVP list are selected from the sorted single/joint groups.
      3. Alternatively, partial candidates in the preliminary MVP list are selected from the sorted groups, and the rest candidates are included into the list with other rules.
      4. In one example, in the second pass, all the candidates in the preliminary list, regardless of the corresponding categories, are sorted based on a cost (e.g., template matching cost), and only limited number of candidates are included into the ultimate MVP list based on the sorted order.
         a) Alternatively, furthermore, all the candidates in the preliminary MVP list are included in the ultimate MVP list in accordance with the sorted order.
      5. The cost (e.g., template matching cost) calculated in a former pass can be re-used in a later pass.
         a) In one example, when the cost for a certain candidate is calculated in a former pass, it will be saved in a variable or any other data structure in case the same cost is needed in a later pass.
         b) In one example, in a later pass, if the cost for a certain candidate is needed, it will first check whether this cost has been calculated before or not. If this cost has been calculated and/or saved before, and/or is accessible in the current pass, it will be fetched in the current pass instead of calculating again.

7. At least one virtual candidate (e.g., pairwise MVP and zero MVP) may be involved in the at least one group.
a) In one example, all the virtual candidates are treated with one joint group.
   i. Alternatively, each category of virtual candidates is treated as a single group.
   ii. In one example, the pairwise MVP and/or zero MVP are included in a single/joint group.
   iii. Alternatively, furthermore, the group which contains the virtual candidates is reordered and then put into a candidate list.
b) Alternatively, the virtual candidates (e.g., pairwise MVP and/or zero MVP) are not included in any single/joint group.
   i. Alternatively, furthermore, no reordering process is applied to virtual candidates.
      1. Alternatively, furthermore, they may be further appended to candidate list.
   ii. In one example, one or more single/joint groups are constructed, where partial or all of the groups are reordered. In this case, at least one position in MVP list is preserved for the virtual candidates (e.g., pairwise MVP and/or zero MVP), which are appended to MVP list as the last or any other entry.
   iii. In one example, furthermore, a single group of adjacent candidates is firstly included in the MVP list, then a joint group of non-adjacent and HMVP are reordered and subsequently appended to MVP list. In this case, at least one position is preserved for the virtual candidates (e.g., pairwise MVP and/or zero MVP), which are appended to MVP list as the last or any other entry.
   iv. In one example, furthermore, a joint group of adjacent candidates, non-adjacent and HMVP are reordered and subsequently appended to MVP list, and the virtual candidates (e.g., pairwise MVP and/or zero MVP) are appended to MVP list as the last or any other entry.
c) Alternatively, the virtual candidates (e.g., pairwise MVP) of one category is included in a single/joint group and the virtual candidates of another category is not included.
d) In one example, no virtual candidates (e.g., pairwise MVP and/or zero MVP) appear in the ultimate MVP list when reordering operation is performed for MVP list construction.

8. The number of candidates of a single/joint group may not be allowed to exceed a maximum candidate number.
a) In one example, a single/joint group is constructed with limited amount of candidates constrained by maximum number Nᵢ, where i∈[0, 1 . . . , K] is the index of the corresponding group. Nᵢ may be the same or they may be different for different i.
b) In one example, partial candidates in a single/joint group are limited by maximum number Nᵢ.
   i. In one example, one or multiple categories of candidates in a group are constructed with limited amount Nᵢ, while other categories in the same group can be included with arbitrary number.
      1. In one example, the categories include but not limited to adjacent candidates, non-adjacent candidates, HMVP, pairwise candidates, etc.
c) Alternatively, a first single/joint group may be constructed with at most Nᵢ MVP candidates, while a second single/joint groups may not have such constraint.
d) In one example, Nᵢ is a fix value shared by both encoder and decoder.
   i. Alternatively, Nᵢ is determined by encoder and signalled in the bitstream. And decoder decodes Nᵢ value and then construct the corresponding iₜₕ single/joint group with at most Nᵢ candidates.
   ii. Alternatively, Nᵢ is derived in both encoder and decoder with the same operations, such that there is no need to signal the Nᵢ value.
      1. In one example, encoder and decoder may derive the Nᵢ value based on the variance of all available motion information for iₜₕ group.
      2. Alternatively, encoder and decoder may derive the Nᵢ value based on the number of all available candidates for iₜₕ group.
      3. In one example, encoder and decoder may derive the Nᵢ value based on the number of the available adjacent candidates.
         a) In one example, Nᵢ is set to N-NADJ, where N is a constant, N_{ADJ} is the number of the available adjacent candidates.
      4. Alternatively, furthermore, encoder and decoder may derive the Nᵢ value based on any information that encoder/decoder can both access to when constructing the MVP list.
e) In one example, all or partial of the single/joint groups may share a same maximum candidate number N.

9. The construction of a single/joint group may depend on the maximum number constraint Nᵢ.
a) In one example, all available MVP candidates for iₜₕ group are included in the group in accordance with a certain order. Once the candidate number in the current group reaches Nᵢ, the construction for group i is terminated.
b) In one example, in above case, the order for group construction may be derived based on the distance between to-be-coded CU and MVP candidates, where a closer MVP candidate is assigned with a higher priority.
c) Alternatively, the order may be derived based on a cost (such as a template matching) cost, where an MVP with a less cost has a higher priority.
d) In one example, the construction of single/joint group is performed with at least one pruning operation in at least one group, or between groups.
e) In one example, the constructed single/joint group is further reordered based on at least one cost method (e.g., template matching cost), then some or all of the candidates in this group may be included in the MVP list.
   i. Alternatively, the candidates in the constructed single/joint group will not be further reordered, and some or all of the candidates in this group are included into the MVP list in the same order as they are included in the group.

10. On how to prune MVP candidates.
a) In one example, K-pass (e.g., K=2) pruning is performed to build an MVP list.
   1. In one example, a first pruning may be performed inside at least one single/joint group, and a second pass pruning may be performed between at least two candidates that belong to different groups.
      a) In one example, in the first pass pruning, the pruning thresholds for two single/joint groups may be the same, or may be different.
      b) In one example, furthermore, in the first pass pruning, some of single/joint groups may share a same threshold value, while other single/joint groups may use different threshold values.
   2. In one example, furthermore, the threshold for a certain pass or group is determined by the decoding information, including but not limited to the block size, coding tools been used (e.g., TM, DMVR, adaptive DMVR, CIIP, AFFINE, AMVP-merge).
      a) Alternatively, a threshold may be determined by at least one syntax element signaled to the decoder.

### 3. PROBLEMS

1) Existing MVP list construction methods target at building a subset with constant MVP number from a given candidate set, which is normally realized by selecting the available candidates in a predefined order. This strategy, however, does not exploit the prior information produced during encoding/decoding process, which may lead to the mismatch between the true motion information and that of the candidates in the constructed MVP list.

2) Existing pruning process for MVP candidate only regards identical MVs as redundancy. Consequently, the constructed MVP list may contain quite similar MVs such that the diversity within the list is limited.

### 4. DETAILED SOLUTIONS

In this disclosure, an enhanced MVP list derivation method based on template matching cost ordering is proposed. Instead of constructing the MVP list based on a predefined traversing order, an optimized MVP selecting approach is investigated by taking advantage of the matching cost in the reconstructed template region, such that more appropriate candidates are included in the list.

It should be noted that the proposed strategy for MVP list construction can be utilized in normal merge and AMVP list construction process and can also be easily extended to other modules that require MVP derivation, e.g., merge with motion vector difference (MMVD), Affine motion compensation, Subblock-based temporal motion vector prediction (SbTMVP) and so on.

In the following discussion, category represents the belongingness of an MVP candidate, e.g., non-adjacent MVP candidates belong to one category; HMVP candidates belonging to another category. A group denotes an MVP candidate set which contains one or multiple MVP candidates. In one example, a single group denotes an MVP candidate set in which all the candidates belong to one category, e.g., adjacent MVP, non-adjacent MVP, HMVP, etc. In another example, a joint group denotes an MVP candidate set which contains candidates from multiple categories.

In the following discussion, “cost” of a candidate may be derived based on template matching or Bilateral matching, with functions such as SAD/SATD/SSD/MR-SAD (mean removal SAD).

The detailed embodiments below should be considered as examples to explain general concepts. These embodiments should not be interpreted in a narrow way. Furthermore, these embodiments can be combined in any manner. Combination between this patent application and others are also applicable.

1. Multiple thresholds may be utilized to determine whether a candidate could be added to a candidate list in the candidate pruning process.
a) A threshold may be used to determine whether a potential candidate can be put into a candidate list.
   i. For example, if the absolute difference of at least one component of the MV of the potential candidate and that of a candidate existing in the candidate list is smaller than a threshold, the potential candidate is not put into the list.
   ii. For example, if the absolute difference of all components of the MV of the potential candidate and that of a candidate existing in the candidate list is smaller than a threshold, the potential candidate is not put into the list.
b) In one example, the candidate is an MVP candidate, the candidate pruning process is the MVP candidate pruning process, and the candidate list is a motion candidates list.
   i. In one example, the motion candidate list is a merge candidate list.
   ii. In one example, the motion candidate list is a AMVP candidate list.
   iii. In one example, the motion candidate list is an extend merge or AMVP list, such as sub-block merge candidate list, affine merge candidate list, MMVD list, GPM list, template matching merge list, biliteral matching merge list etc.
   iv. In one example, the motion candidate list is an IBC merge candidate list.
   v. In one example, the motion candidate list is an IBC AMVP candidate list.
   vi. In one example, the motion candidate list is an extend IBC merge or IBC AMVP list, such as IBC-MMVD list.
c) In one example, the pruning thresholds may be different for two groups, where the group can be either a single group (containing only one category of candidates) or a joint group (containing at least two categories of candidates).
d) In one example, N (e.g., N=2) thresholds are used in the pruning process.
   i. Assume A is the MVP set which contains all available MVP candidates regardless of category, in one example, a first threshold is used for a first subset of candidates in set A, and a second threshold is used for a second subset of candidates (e.g., the rest candidates excluding those in the first subset) in set A.
   ii. In one example, a first threshold is used for a single group denoted by A, and a second threshold is used for another group (single or joint)/multiple other groups/rest of candidates which are not with the same category as those in A.
      1) In one example, a first threshold is used for the single group of adjacent candidates, and a second threshold is used for the rest candidates, including but not limited to non-adjacent MVP, HMVP, pairwise MVP and zero MVP.
   iii. The first threshold may be larger than or smaller than the second threshold.
e) In one example, K-pass (e.g., K=4) pruning are conducted to construct MVP list.
   i. In one example, the 1^{st} pass pruning (termed as P1) is performed within single or joint group to avoid duplicate candidates.
      1) In one example, partial or all of the groups may sort (i.e., ARMC) after P1.
   ii. In one example, the 2nd pass pruning (termed as P2) is performed when multiple groups are merged into one or multiple hybrid group(s).
      1) In one example, the hybrid group(s) may perform sorting or not after P2.
   iii. In one example, some new candidates may be inserted into the hybrid group, and the 3rd pass pruning is triggered to ensure no duplicate exists after the new candidates added.
   iv. In one example, the 4th pass pruning (termed as P4) is performed to further increase the diversity within the hybrid group(s).
   v. In one example, the multiple pass pruning described above may be utilized in a separate or combined way.
      1) In one example, only partial pass is used to construct MVP list, i.e., P1->P2->p4, P1->P2->p3, P1->P2, P1->P3, P1->P3->p4, P1->p4 etc.
      2) In one example, the order of each pass may change during the construction process, i.e., a later pass pruning may perform before a former pass pruning.
      3) In one example, certain pruning pass may perform multiple time during the construction.
         a) In one example, the pruning may performed in order of P1->P4->P2->P3->p4.
   vi. In one example, the threshold used in different passes may be the same or different.
      1) In one example, the threshold in a certain pass pruning may be a constant.
      2) In one example, the threshold in a certain pass pruning may be derived from the bitstream.
         a) In one example, all available threshold values may be stored in a look-up table or any other data structure, and the index of the selected threshold is signalled in the bitstream. The decoder may first parse the threshold index and then fetches the threshold value from the corresponding look-up table or other data structure.
         b) In one example, the threshold may be derived based on the information of current block, i.e., QP or Lagrange multiplier (Lamda) used in RDO process.

2. On how to construct MVP list.
a) One or multiple groups may be firstly constructed, where each group comprises the candidates belong to one or multiple categories.
   i. In one example, the category may include but not limited to adjacent MVP, non-adjacent MVP, HMVP, pairwise MVP, constructed MVP, etc.
   ii. In one example, the candidate number in each group may not be allowed to exceed a certain value.
      1) In one example, the maximum allowed number for each group may be a constant or determined on-the-fly.
      2) In one example, the maximum allowed number for each group may be different.
   iii. In one example, if only one group is constructed, the candidates belong to different categories are inserted into the group based on a pre-defined order.
      1) In one example, specifically, in the constructed group, the candidates number of certain one or multiple categories cannot exceed a constant or a value that determined on-the-fly.
   iv. Pruning operation may be performed or not during the construction of each group.
      1) In one example, specifically, the pruning is performed within the group, i.e., no duplicate exists for arbitrary two candidates that are from arbitrary one group.
      2) Alternatively, the pruning is performed among the group, i.e., no duplicate exists for arbitrary two candidates that are from arbitrary one or two group.
   v. Pruning threshold for arbitrary two groups may be the same or not.
b) If multiple groups have been constructed, some or all groups may then merge into a hybrid group.
   i. In one example, if only one group is constructed in a), then no merging process is conducted and this group will be regarded as a special case of hybrid group.
   ii. In one example, specifically, if the group(s) before merging have not performed pruning or already performed within-group pruning, then a second pass pruning is performed during the merging process.
   iii. Alternatively, specifically, if the group(s) before merging have already performed among-group pruning, no pruning is performed during the merging process.
c) Subsequently, the hybrid group may be sorted based on ARMC or any other metric.
   i. In one example, specifically, before or after the hybrid group is sorted, all or partial candidates within the group may be refined by template or bilateral matching.
   ii. In one example, specifically, zero MVPs are excluded in the sorting process, which may be forced to place at the end of the sorted list.
d) Constructed candidates (i.e., Pairwise candidates) may be generated and/or inserted into the hybrid group, and/or another round of sorting may be evoked to reorder the extended group.
   i. In one example, the constructed candidates may be generated based on the sorted group.
      1) In one example, specifically, the constructed candidates can be pairwise candidates.
      2) In one example, specifically, the constructed candidates are inserted in the hybrid group along with pruning operation.
e) Finally, the last round pruning is performed to further increase the diversity within the larger group(s).
   i. In one example, the template matching cost for all the candidates in the sorted list are calculated, and the minimum cost difference between a candidate and its predecessor among all candidates in the list is determined. If this minimum cost difference is smaller than TH, the candidate will be discarded and it is moved at a further position in the list. This further position is the first position where the cost difference relative to its predecessor is larger than TH. This algorithm stops after a finite number of iterations, or the remaining candidates number reaches the target value for the MVP list.
      a) In one example, the TH may be derived based on the information of current block, i.e., QP or Lagrange multiplier (Lamda) used in RDO process.

3. The disclosed methods above can be applied on potential candidates before being put into the candidate list, or may be applied on candidates after being put into the candidate list.

### 4. GENERAL CLAIMS

1) Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.

2) Whether to and/or how to apply the disclosed methods above may be signalled at PB/TB/CB/PU/TU/CU/VPDU/CTU/CTU row/slice/tile/sub-picture/other kinds of region contain more than one sample or pixel.

3) Whether to and/or how to apply the disclosed methods above may be dependent on coded information, such as block size, colour format, single/dual tree partitioning, colour component, slice/picture type.

### 5. EMBODIMENTS

In one example, when encoder/decoder starts to build an MVP candidate list, multiple small groups will be firstly constructed, where each group comprises the candidates from one or multiple categories. In particular, the number of the candidate in each group should not exceed the maximum allowed number, wherein the maximum number may vary from one group to another. Besides, within-group pruning operation with a constant threshold is conducted along with the construction of each group. After each group is constructed, all or partial of them will further merge into a hybrid group, here the 2^{nd} pass pruning is triggered to exclude the redundant candidates in the larger group. Then, all or partial of the candidates in the mixed group are sorted based on ARMC method, and it should be noted that all or partial candidates before ARMC may be firstly refined by template matching or bilateral matching. Based on the sorted hybrid group, some constructed candidates, i.e., pairwise candidates, may be generated and then insert into the hybrid group along with the 3^{rd} pass pruning operation. And the extended hybrid group performs ARMC again and all the candidates are sorted based on the TM cost. Lastly, if the candidate number in the hybrid group is larger than the maximum allowed value for the MVP list, the final pass pruning operation is conducted. In particular, the template matching cost for all the candidates in the sorted group are calculated, and the minimum cost difference between a candidate and its predecessor among all candidates is determined. If this minimum cost difference is smaller than a constant TH, the candidate will be discarded and it is moved at a further position in the list. This further position is the first position where the cost difference relative to its predecessor is larger than TH. This algorithm stops after a finite number of iterations, or the remaining candidates number reaches the target value for the MVP list.

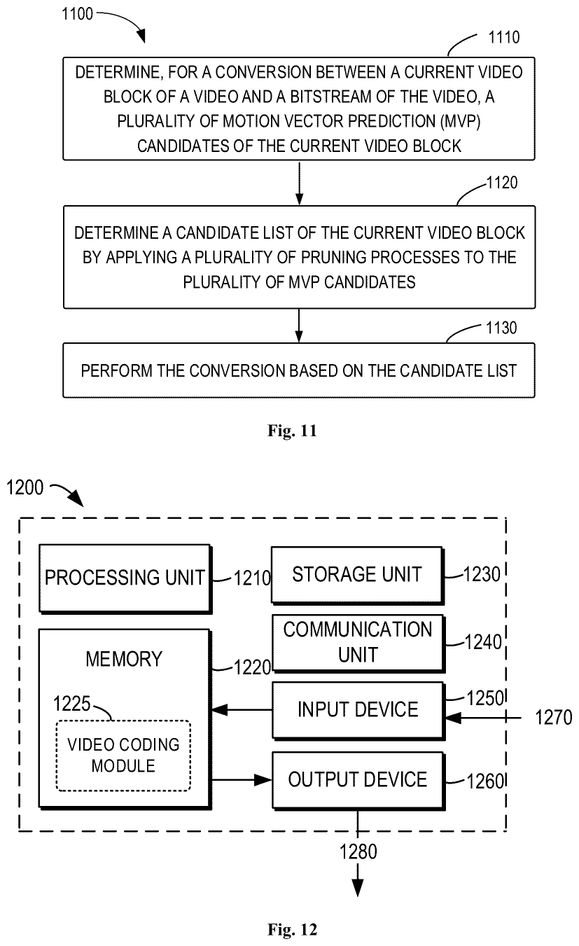

FIG. 11 illustrates a flowchart of a method 1100 for video processing in accordance with embodiments of the present disclosure. The method 1100 may be implemented for a conversion between a current video block of a video and a bitstream of the video.

At block 1110, a plurality of motion vector prediction (MVP) candidates of the current video block is determined. At block 1120, a candidate list of the current video block is determined by applying a plurality of pruning processes to the plurality of MVP candidates. For example, K-pass (K being an integer greater than 1, e.g., K=4) pruning processes may be conducted to construct MVP list. At block 1130, the conversion is performed based on the candidate list.

The method 1100 enables determining the candidate list of the current video block by applying a plurality of pruning processes. It thus can avoid redundant candidate in the candidate list and improve the diversity of the candidate list. In this way, the coding efficiency and coding effectiveness can be improved.

In some embodiments, the plurality of pruning processes comprises a first pass pruning process, and determining the candidate list comprises: determining a group of MVP candidates based on the plurality of MVP candidates; applying the first pass pruning process to the group of MVP candidates; and determining the candidate list based on the pruned group of MVP candidates. For example, the Ist pass pruning (termed as P1) is performed within single or joint group to avoid duplicate candidates.

In some embodiments, the group comprises at least one of: a single group of MVP candidates of a single candidate category, or a joint group of MVP candidates of a plurality of candidate categories.

In some embodiments, the method 1100 further comprises: sorting at least a partial of the pruned group of MVP candidates.

In some embodiments, the sorting is based on an adaptive reordering merge candidates (ARMC) process. For example, partial or all of the groups may sort (i.e., ARMC) after P1.

In some embodiments, the plurality of pruning processes comprises a second pass pruning process, and determining the candidate list comprises: determining a plurality of groups of MVP candidates based on the plurality of MVP candidates; determining at least one hybrid group of MVP candidate based on the plurality of groups; applying the second pass pruning process to the at least one hybrid group of MVP candidates; and determining the candidate list based on the at least one pruned hybrid group of MVP candidates. For example, the 2^{nd} pass pruning (termed as P2) is performed when multiple groups are merged into one or multiple hybrid group(s).

In some embodiments, the method 1100 further comprises: sorting the at least one pruned hybrid group of MVP candidates. Alternatively, in some embodiments, the at least one pruned hybrid group of MVP candidates is not sorted.

In some embodiments, the plurality of pruning processes comprises a third pass pruning process, and determining the candidate list comprises: determining a plurality of groups of MVP candidates based on the plurality of MVP candidates; determining at least one hybrid group of MVP candidates based on the plurality of groups; updating the at least one hybrid group by adding at least one MVP candidate into the at least one hybrid group; applying the third pass pruning process to the at least one hybrid group; and determining the candidate list based on the at least one pruned hybrid group of MVP candidates. For example, some new candidates may be inserted into the hybrid group, and the 3^{rd} pass pruning is triggered to ensure no duplicate exists after the new candidates added.

In some embodiments, the plurality of pruning processes comprises a fourth pass pruning process, and determining the candidate list based on the at least one pruned hybrid group comprises: applying the fourth pass pruning process to the at least one pruned hybrid group; and determining the candidate list based on the at least one pruned hybrid group of MVP candidates. For example, the 4th pass pruning (termed as P4) is performed to further increase the diversity within the hybrid group(s).

In some embodiments, the plurality of pruning processes is utilized separately or in combination. For example, the multiple pass pruning described above may be utilized in a separate or combined way.

In some embodiments, applying the plurality of pruning processes to the plurality of MVP candidates comprises: applying at least a partial of plurality of pruning processes to the plurality of MVP candidates based on an order of the plurality of pruning processes.

In some embodiments, the order of the plurality of pruning processes comprises one of: a first order of a first pass pruning process, a second pass pruning process, and a fourth pass pruning process, a second order of a first pass pruning process, a second pass pruning process, and a third pass pruning process, a third order of a first pass pruning process, and a second pass pruning process, a fourth order of a first pass pruning process, and a third pass pruning process, a fifth order of a first pass pruning process, a third pass pruning process, and a fourth pass pruning process, a sixth order of a first pass pruning process, and a fourth pass pruning process, or a seventh order of a first pass pruning process, a fourth pass pruning process, a second pass pruning process, a third pass pruning process, and a fourth pass pruning process. That is, partial pass is used to construct MVP list, i.e., P1->P2->p4, P1->P2->p3, P1->P2, P1->P3, P1->P3->p4, P1->p4, etc.

In some embodiments, the order of the plurality of pruning processes is changed during the conversion. For example, the order of each pass may change during the construction process, i.e., a later pass pruning may perform before a former pass pruning.

In some embodiments, a first pruning process of the plurality of pruning processes is performed for a plurality of times during the conversion.

In some embodiments, applying the plurality of pruning processes to the plurality of MVP candidates comprises: applying the plurality of pruning processes to the plurality of MVP candidates based on a plurality of thresholds, wherein a threshold of the plurality of thresholds is used to determine whether an MVP candidate of the plurality of MVP candidates is to be added into the candidate list.

In some embodiments, the plurality of thresholds for the plurality of pruning processes is the same or different. For example, the threshold used in different passes may be the same or different.

In some embodiments, a first threshold associated with a pruning process of the plurality of pruning processes is a constant.

In some embodiments, the first threshold is determined from the bitstream. In some embodiments, the method 1100 further comprises: determining the first threshold based on coding information of the current video block.

In some embodiments, the coding information of the current video block comprises at least one of: quantization parameter (QP) of the current video block, or a parameter associated with a rate distortion optimization (RDO) process.

In some embodiments, a plurality of candidate threshold values is stored in a data structure, and the first threshold is determined by: determining an index of the first threshold from the bitstream; and obtaining the first threshold from the data structure based on the index. For example, the data structure may comprise a look up table.

In some embodiments, determining the candidate list by applying a plurality of pruning processes to the plurality of MVP candidates comprises: for a first pruning process of the plurality of pruning processes, determining whether an absolute difference of at least one component of a motion vector (MV) of an MVP candidate of the plurality of MVP candidates and at least one component of a candidate in the candidate list is smaller than a threshold; and in accordance with a determination that the absolute difference is larger than or equal to the threshold, add the MVP candidate into the candidate list.

In some embodiments, the candidate list comprises a motion candidate list. In some embodiments, the motion candidate list comprises at least one of: a merge candidate list, an advanced motion vector prediction (AMVP) candidate list, an extend merge or AMVP list, a sub-block merge candidate list, an affine merge candidate list, a merge with motion vector difference (MMVD) list, a geometric partitioning mode (GPM) list, a template matching merge list, a biliteral matching merge list, an intra block copy (IBC) merge candidate list, an IBC AMVP candidate list, an extend IBC merge or IBC AMVP list, or an IBC-MMVD list.

In some embodiments, a first threshold for a first pruning process of the plurality of pruning processes is different from a second threshold for a second pruning process of the plurality of pruning processes, the first pruning process is applied to a first group of candidates, and the second pruning process is applied to a second group of candidates.

In some embodiments, the first group or the second group comprises at least one of: a single group of MVP candidates of a single candidate category, or a joint group of MVP candidates of a plurality of candidate categories.

In some embodiments, a first threshold for a first pruning process of the plurality of pruning processes is different from a second threshold for a second pruning process of the plurality of pruning processes, the first pruning process is applied to a first subset of candidates of the plurality of MVP candidates, and the second pruning process is applied to a remaining subset of candidates of the plurality of MVP candidates.

In some embodiments, the first subset of candidates comprises a single group of candidates associated with a first candidate category, and a candidate in the remaining subset being associated with a second candidate category different from the first candidate category.

In some embodiments, the first subset comprises adjacent candidates, and the remaining subset comprises at least one of: a non-adjacent MVP candidate, a history-based MVP (HMVP) candidate, a pairwise MVP candidate, or a zero MVP candidate. In some embodiments, the first threshold is larger than or smaller than the second threshold.

In some embodiments, determining the candidate list comprises: determining at least one group of candidates based on the plurality of MVP candidates, a group of candidates comprising MVP candidates associated with at least one candidate category; determining a hybrid group of candidates based on the at least one group; sorting the hybrid group of candidates; updating the sorted hybrid group by adding at least one candidate into the sorted hybrid group; and determining the candidate list by applying a last round pruning to the updated hybrid group of candidates.

In some embodiments, the at least one candidate category comprises at least one of: an adjacent MVP candidate category, a non-adjacent MVP candidate category, a history-based MVP (HMVP) candidate category, a pairwise MVP candidate category, or a constructed MVP candidate category.

In some embodiments, the number of candidates in the at least one group is less than or equal to a threshold number.

In some embodiments, the threshold is a constant or is determined during the conversion. In some embodiments, the threshold number for each of the at least one group is different.

In some embodiments, the at least one group comprises a single group, and determining the single group comprises: adding the plurality of MVP candidates into the single group based on a predefined order of candidate category.

In some embodiments, the number of candidates associated with a candidate category is less than or equal to a threshold number, the threshold number being a constant or being determined during the conversion.

In some embodiments, at least one pruning process is applied to the at least one group of candidates, or at least one pruning process is not applied to the at least one group of candidates.

In some embodiments, the at least one pruning process is performed within the at least one group. In some embodiments, the at least one pruning process is performed among the at least one group.

In some embodiments, at least one pruning threshold for the at least one group is the same or different.

In some embodiments, if the at least one group comprises a single group, the hybrid group is the single group.

In some embodiments, the at least one group comprises a plurality of groups without being applied a first pass pruning process, and determining the hybrid group comprises: applying a second pass pruning process during a merging process for merging the plurality of groups into the hybrid group.

In some embodiments, the at least one group comprises a plurality of groups being applied a first pass pruning process, and determining the hybrid group comprises: merging the plurality of groups into the hybrid group without applying a second pass pruning process.

In some embodiments, the hybrid group of candidates is sorted based on at least one of: adaptive reordering merge candidates (ARMC), or a further metric.

In some embodiments, the method 1100 further comprises: refining at least a partial of the hybrid group based on at least one of: template matching or bilateral matching before or after sorting the hybrid group.

In some embodiments, a zero MVP in the hybrid group is placed at an end of the sorted hybrid group.

In some embodiments, the at least one candidate comprises a constructed candidate.

In some embodiments, the method 1100 further comprises: sorting the updated hybrid group of candidates.

In some embodiments, the constructed candidate is generated based on the sorted hybrid group.

In some embodiments, the constructed candidate comprises a pairwise candidate.

In some embodiments, a pruning process is applied to the updated hybrid group.

In some embodiments, applying a last round pruning to the updated hybrid group of candidates comprises: determining a plurality of template matching costs for candidates in the updated hybrid group of candidates; and selecting a first candidate from the updated hybrid group and determining whether to discard the first candidate by: determining a minimum cost difference between the first candidate in the updated hybrid group and remaining candidates in the updated hybrid group; and in accordance with a determination that the minimum cost difference is smaller than a threshold, discard the first candidate from the updated hybrid group; and selecting a second candidate from the updated hybrid group and determining whether to discard the second candidate.

In some embodiments, the second candidate is in a position where a cost difference relative to a candidate in the MVP candidate list is larger than the threshold. In some embodiments, the selecting the second candidate and determining whether to discard the second candidate is stopped after a predefined number of iterations, or after the number of candidates in the MVP candidate list reaching a predefined number.

In some embodiments, the template matching cost for all the candidates in the sorted list are calculated, and the minimum cost difference between a candidate and its predecessor among all candidates in the list is determined. If this minimum cost difference is smaller than the threshold (TH), the candidate will be discarded and it is moved at a further position in the list. This further position is the first position where the cost difference relative to its predecessor is larger than TH. This algorithm stops after a finite number of iterations, or the remaining candidates number reaches the target value for the MVP list.

In some embodiments, the threshold is determined based on coding information of the current video block. In some embodiments, the coding information of the current video block comprises at least one of: a quantization parameter (QP) of the current video block, or a parameter associated with a rate distortion optimization (RDO) process. For example, the TH may be derived based on the information of current block, i.e., QP or Lagrange multiplier (Lamda) used in RDO process.

In some embodiments, the method is applied to a first candidate before the first candidate being added into the candidate list, or applied to a second candidate after the second candidate being added into the candidate list.

In some embodiments, information regarding applying the method is included in the bitstream.

In some embodiments, the information is included in at least one of: a sequence level, a group of pictures level, a picture level, a slice level, a tile group level, a sequence header. a picture header, a sequence parameter set (SPS), a video parameter set (VPS), a decoded parameter set (DPS), decoding capability information (DCI), a picture parameter set (PPS), an adaptation parameter set (APS), a slice header, or a tile group header.

In some embodiments, the information is included in a region containing more than one sample or pixel.

In some embodiments, the region comprising one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

In some embodiments, the information is based on coded information of the current video block.

In some embodiments, the coded information comprises at least one of: a coding mode, a block size, a colour format, a single or dual tree partitioning, a colour component, a slice type, or a picture type.

According to further embodiments of the present disclosure, a non-transitory computer-readable recording medium is provided. The non-transitory computer-readable recording medium stores a bitstream of a video which is generated by a method performed by an apparatus for video processing. In the method, a plurality of motion vector prediction (MVP) candidates of a current video block of the video is determined. A candidate list of the current video block is determined by applying a plurality of pruning processes to the plurality of MVP candidates. The bitstream is generated based on the candidate list.

According to still further embodiments of the present disclosure, a method for storing bitstream of a video is provided. In the method, a plurality of motion vector prediction (MVP) candidates of a current video block of the video is determined. A candidate list of the current video block is determined by applying a plurality of pruning processes to the plurality of MVP candidates. The bitstream is generated based on the candidate list. The bitstream is stored in a non-transitory computer-readable recording medium.

Implementations of the present disclosure can be described in view of the following clauses, the features of which can be combined in any reasonable manner.

Clause 1. A method for video processing, comprising: determining, for a conversion between a current video block of a video and a bitstream of the video, a plurality of motion vector prediction (MVP) candidates of the current video block; determining a candidate list of the current video block by applying a plurality of pruning processes to the plurality of MVP candidates; and performing the conversion based on the candidate list.

Clause 2. The method of clause 1, wherein the plurality of pruning processes comprises a first pass pruning process, and determining the candidate list comprises: determining a group of MVP candidates based on the plurality of MVP candidates; applying the first pass pruning process to the group of MVP candidates; and determining the candidate list based on the pruned group of MVP candidates.

Clause 3. The method of clause 2, wherein the group comprises at least one of: a single group of MVP candidates of a single candidate category, or a joint group of MVP candidates of a plurality of candidate categories.

Clause 4. The method of clause 2 or clause 3, further comprising: sorting at least a partial of the pruned group of MVP candidates.

Clause 5. The method of clause 4, wherein the sorting is based on an adaptive reordering merge candidates (ARMC) process.

Clause 6. The method of any of clauses 1-5, wherein the plurality of pruning processes comprises a second pass pruning process, and determining the candidate list comprises: determining a plurality of groups of MVP candidates based on the plurality of MVP candidates; determining at least one hybrid group of MVP candidate based on the plurality of groups; applying the second pass pruning process to the at least one hybrid group of MVP candidates; and determining the candidate list based on the at least one pruned hybrid group of MVP candidates.

Clause 7. The method of clause 6, further comprising: sorting the at least one pruned hybrid group of MVP candidates.

Clause 8. The method of clause 6, wherein the at least one pruned hybrid group of MVP candidates is not sorted.

Clause 9. The method of any of clauses 1-8, wherein the plurality of pruning processes comprises a third pass pruning process, and determining the candidate list comprises: determining a plurality of groups of MVP candidates based on the plurality of MVP candidates; determining at least one hybrid group of MVP candidates based on the plurality of groups; updating the at least one hybrid group by adding at least one MVP candidate into the at least one hybrid group; applying the third pass pruning process to the at least one hybrid group; and determining the candidate list based on the at least one pruned hybrid group of MVP candidates.

Clause 10. The method of clause 9, wherein the plurality of pruning processes comprises a fourth pass pruning process, and determining the candidate list based on the at least one pruned hybrid group comprises: applying the fourth pass pruning process to the at least one pruned hybrid group; and determining the candidate list based on the at least one pruned hybrid group of MVP candidates.

Clause 11. The method of any of clauses 1-10, wherein the plurality of pruning processes is utilized separately or in combination.

Clause 12. The method of any of clauses 1-11, wherein applying the plurality of pruning processes to the plurality of MVP candidates comprises: applying at least a partial of plurality of pruning processes to the plurality of MVP candidates based on an order of the plurality of pruning processes.

Clause 13. The method of clause 12, wherein the order of the plurality of pruning processes comprises one of: a first order of a first pass pruning process, a second pass pruning process, and a fourth pass pruning process, a second order of a first pass pruning process, a second pass pruning process, and a third pass pruning process, a third order of a first pass pruning process, and a second pass pruning process, a fourth order of a first pass pruning process, and a third pass pruning process, a fifth order of a first pass pruning process, a third pass pruning process, and a fourth pass pruning process, a sixth order of a first pass pruning process, and a fourth pass pruning process, or a seventh order of a first pass pruning process, a fourth pass pruning process, a second pass pruning process, a third pass pruning process, and a fourth pass pruning process.

Clause 14. The method of clause 13, wherein the order of the plurality of pruning processes is changed during the conversion.

Clause 15. The method of any of clauses 12-14, wherein a first pruning process of the plurality of pruning processes is performed for a plurality of times during the conversion.

Clause 16. The method of any of clauses 1-11, wherein applying the plurality of pruning processes to the plurality of MVP candidates comprises: applying the plurality of pruning processes to the plurality of MVP candidates based on a plurality of thresholds, wherein a threshold of the plurality of thresholds is used to determine whether an MVP candidate of the plurality of MVP candidates is to be added into the candidate list.

Clause 17. The method of clause 16, wherein the plurality of thresholds for the plurality of pruning processes is the same or different.

Clause 18. The method of clause 16 or clause 17, wherein a first threshold associated with a pruning process of the plurality of pruning processes is a constant.

Clause 19. The method of clause 18, wherein the first threshold is determined from the bitstream.

Clause 20. The method of clause 18 or clause 19, further comprising: determining the first threshold based on coding information of the current video block.

Clause 21. The method of clause 20, wherein the coding information of the current video block comprises at least one of: quantization parameter (QP) of the current video block, or a parameter associated with a rate distortion optimization (RDO) process.

Clause 22. The method of clause 18 or clause 19, wherein a plurality of candidate threshold values is stored in a data structure, and the first threshold is determined by: determining an index of the first threshold from the bitstream; and obtaining the first threshold from the data structure based on the index.

Clause 23. The method of clause 22, wherein the data structure comprises a look up table.

Clause 24. The method of any of clauses 1-23, wherein determining the candidate list by applying a plurality of pruning processes to the plurality of MVP candidates comprises: for a first pruning process of the plurality of pruning processes, determining whether an absolute difference of at least one component of a motion vector (MV) of an MVP candidate of the plurality of MVP candidates and at least one component of a candidate in the candidate list is smaller than a threshold; and in accordance with a determination that the absolute difference is larger than or equal to the threshold, add the MVP candidate into the candidate list.

Clause 25. The method of any of clauses 1-24, wherein the candidate list comprises a motion candidate list.

Clause 26. The method of clause 25, wherein the motion candidate list comprises at least one of: a merge candidate list, an advanced motion vector prediction (AMVP) candidate list, an extend merge or AMVP list, a sub-block merge candidate list, an affine merge candidate list, a merge with motion vector difference (MMVD) list, a geometric partitioning mode (GPM) list, a template matching merge list, a biliteral matching merge list, an intra block copy (IBC) merge candidate list, an IBC AMVP candidate list, an extend IBC merge or IBC AMVP list, or an IBC-MMVD list.

Clause 27. The method of any of clauses 1-26, wherein a first threshold for a first pruning process of the plurality of pruning processes is different from a second threshold for a second pruning process of the plurality of pruning processes, the first pruning process is applied to a first group of candidates, and the second pruning process is applied to a second group of candidates.

Clause 28. The method of clause 27, wherein the first group or the second group comprises at least one of: a single group of MVP candidates of a single candidate category, or a joint group of MVP candidates of a plurality of candidate categories.

Clause 29. The method of any of clauses 1-28, wherein a first threshold for a first pruning process of the plurality of pruning processes is different from a second threshold for a second pruning process of the plurality of pruning processes, the first pruning process is applied to a first subset of candidates of the plurality of MVP candidates, and the second pruning process is applied to a remaining subset of candidates of the plurality of MVP candidates.

Clause 30. The method of clause 29, wherein the first subset of candidates comprises a single group of candidates associated with a first candidate category, and a candidate in the remaining subset being associated with a second candidate category different from the first candidate category.

Clause 31. The method of clause 29 or clause 30, wherein the first subset comprises adjacent candidates, and the remaining subset comprises at least one of: a non-adjacent MVP candidate, a history-based MVP (HMVP) candidate, a pairwise MVP candidate, or a zero MVP candidate.

Clause 32. The method of any of clauses 27-31, wherein the first threshold is larger than or smaller than the second threshold.

Clause 33. The method of any of clauses 1-32, wherein determining the candidate list comprises: determining at least one group of candidates based on the plurality of MVP candidates, a group of candidates comprising MVP candidates associated with at least one candidate category; determining a hybrid group of candidates based on the at least one group; sorting the hybrid group of candidates; updating the sorted hybrid group by adding at least one candidate into the sorted hybrid group; and determining the candidate list by applying a last round pruning to the updated hybrid group of candidates.

Clause 34. The method of clause 33, wherein the at least one candidate category comprises at least one of: an adjacent MVP candidate category, a non-adjacent MVP candidate category, a history-based MVP (HMVP) candidate category, a pairwise MVP candidate category, or a constructed MVP candidate category.

Clause 35. The method of clause 33 or clause 34, wherein the number of candidates in the at least one group is less than or equal to a threshold number.

Clause 36. The method of clause 35, wherein the threshold is a constant or is determined during the conversion.

Clause 37. The method of clause 35, wherein the threshold number for each of the at least one group is different.

Clause 38. The method of any of clauses 33-37, wherein the at least one group comprises a single group, and determining the single group comprises: adding the plurality of MVP candidates into the single group based on a predefined order of candidate category.

Clause 39. The method of clause 38, wherein the number of candidates associated with a candidate category is less than or equal to a threshold number, the threshold number being a constant or being determined during the conversion.

Clause 40. The method of any of clauses 33-39, wherein at least one pruning process is applied to the at least one group of candidates, or at least one pruning process is not applied to the at least one group of candidates.

Clause 41. The method of clause 40, wherein the at least one pruning process is performed within the at least one group.

Clause 42. The method of clause 40, wherein the at least one pruning process is performed among the at least one group.

Clause 43. The method of any of clauses 40-42, wherein at least one pruning threshold for the at least one group is the same or different.

Clause 44. The method of any of clauses 33-43, wherein if the at least one group comprises a single group, the hybrid group is the single group.

Clause 45. The method of any of clauses 33-43, wherein the at least one group comprises a plurality of groups without being applied a first pass pruning process, and determining the hybrid group comprises: applying a second pass pruning process during a merging process for merging the plurality of groups into the hybrid group.

Clause 46. The method of any of clauses 33-43, wherein the at least one group comprises a plurality of groups being applied a first pass pruning process, and determining the hybrid group comprises: merging the plurality of groups into the hybrid group without applying a second pass pruning process.

Clause 47. The method of any of clauses 33-46, wherein the hybrid group of candidates is sorted based on at least one of: adaptive reordering merge candidates (ARMC), or a further metric.

Clause 48. The method of any of clauses 33-47, further comprising: refining at least a partial of the hybrid group based on at least one of: template matching or bilateral matching before or after sorting the hybrid group.

Clause 49. The method of any of clauses 33-48, wherein a zero MVP in the hybrid group is placed at an end of the sorted hybrid group.

Clause 50. The method of any of clauses 33-49, wherein the at least one candidate comprises a constructed candidate.

Clause 51. The method of clause 50, further comprising: sorting the updated hybrid group of candidates.

Clause 52. The method of clause 50 or clause 51, wherein the constructed candidate is generated based on the sorted hybrid group.

Clause 53. The method of any of clauses 50-52, wherein the constructed candidate comprises a pairwise candidate.

Clause 54. The method of any of clauses 50-53, wherein a pruning process is applied to the updated hybrid group.

Clause 55. The method of any of clauses 33-54, wherein applying a last round pruning to the updated hybrid group of candidates comprises: determining a plurality of template matching costs for candidates in the updated hybrid group of candidates; and selecting a first candidate from the updated hybrid group and determining whether to discard the first candidate by: determining a minimum cost difference between the first candidate in the updated hybrid group and remaining candidates in the updated hybrid group; and in accordance with a determination that the minimum cost difference is smaller than a threshold, discard the first candidate from the updated hybrid group; and selecting a second candidate from the updated hybrid group and determining whether to discard the second candidate.

Clause 56. The method of clause 55, wherein the second candidate is in a position where a cost difference relative to a candidate in the MVP candidate list is larger than the threshold.

Clause 57. The method of clause 55 or clause 56, wherein the selecting the second candidate and determining whether to discard the second candidate is stopped after a predefined number of iterations, or after the number of candidates in the MVP candidate list reaching a predefined number.

Clause 58. The method of any of clauses 55-57, wherein the threshold is determined based on coding information of the current video block.

Clause 59. The method of clause 58, wherein the coding information of the current video block comprises at least one of: a quantization parameter (QP) of the current video block, or a parameter associated with a rate distortion optimization (RDO) process.

Clause 60. The method of any of clauses 1-59, wherein the method is applied to a first candidate before the first candidate being added into the candidate list, or applied to a second candidate after the second candidate being added into the candidate list.

Clause 61. The method of any of clauses 1-60, wherein information regarding applying the method is included in the bitstream.

Clause 62. The method of clause 61, wherein the information is included in at least one of: a sequence level, a group of pictures level, a picture level, a slice level, a tile group level, a sequence header. a picture header, a sequence parameter set (SPS), a video parameter set (VPS), a decoded parameter set (DPS), decoding capability information (DCI), a picture parameter set (PPS), an adaptation parameter set (APS), a slice header, or a tile group header.

Clause 63. The method of clause 61, wherein the information is included in a region containing more than one sample or pixel.

Clause 64. The method of clause 63, wherein the region comprising one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a subpicture.

Clause 65. The method of any of clauses 61-64, wherein the information is based on coded information of the current video block.

Clause 66. The method of clause 65, wherein the coded information comprises at least one of: a coding mode, a block size, a colour format, a single or dual tree partitioning, a colour component, a slice type, or a picture type.

Clause 67. The method of any of clauses 1-66, wherein the conversion includes encoding the current video block into the bitstream.

Clause 68. The method of any of clauses 1-66, wherein the conversion includes decoding the current video block from the bitstream.

Clause 69. An apparatus for video processing comprising a processor and a non-transitory memory with instructions thereon, wherein the instructions upon execution by the processor, cause the processor to perform a method in accordance with any of clauses 1-68.

Clause 70. A non-transitory computer-readable storage medium storing instructions that cause a processor to perform a method in accordance with any of clauses 1-68.

Clause 71. A non-transitory computer-readable recording medium storing a bitstream of a video which is generated by a method performed by an apparatus for video processing, wherein the method comprises: determining a plurality of motion vector prediction (MVP) candidates of a current video block of the video; determining a candidate list of the current video block by applying a plurality of pruning processes to the plurality of MVP candidates; and generating the bitstream based on the candidate list.

Clause 72. A method for storing a bitstream of a video, comprising: determining a plurality of motion vector prediction (MVP) candidates of a current video block of the video; determining a candidate list of the current video block by applying a plurality of pruning processes to the plurality of MVP candidates; generating the bitstream based on the candidate list; and storing the bitstream in a non-transitory computer-readable recording medium.

### Example Device

FIG. 12 illustrates a block diagram of a computing device 1200 in which various embodiments of the present disclosure can be implemented. The computing device 1200 may be implemented as or included in the source device 110 (or the video encoder 114 or 200) or the destination device 120 (or the video decoder 124 or 300).

It would be appreciated that the computing device 1200 shown in FIG. 12 is merely for purpose of illustration, without suggesting any limitation to the functions and scopes of the embodiments of the present disclosure in any manner.

As shown in FIG. 12, the computing device 1200 includes a general-purpose computing device 1200. The computing device 1200 may at least comprise one or more processors or processing units 1210, a memory 1220, a storage unit 1230, one or more communication units 1240, one or more input devices 1250, and one or more output devices 1260.

In some embodiments, the computing device 1200 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1200 can support any type of interface to a user (such as “wearable” circuitry and the like).

The processing unit 1210 may be a physical or virtual processor and can implement various processes based on programs stored in the memory 1220. In a multi-processor system, multiple processing units execute computer executable instructions in parallel so as to improve the parallel processing capability of the computing device 1200. The processing unit 1210 may also be referred to as a central processing unit (CPU), a microprocessor, a controller or a microcontroller.

The computing device 1200 typically includes various computer storage medium. Such medium can be any medium accessible by the computing device 1200, including, but not limited to, volatile and non-volatile medium, or detachable and non-detachable medium. The memory 1220 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1230 may be any detachable or non-detachable medium and may include a machine-readable medium such as a memory, flash memory drive, magnetic disk or another other media, which can be used for storing information and/or data and can be accessed in the computing device 1200.

The computing device 1200 may further include additional detachable/non-detachable, volatile/non-volatile memory medium. Although not shown in FIG. 12, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1240 communicates with a further computing device via the communication medium. In addition, the functions of the components in the computing device 1200 can be implemented by a single computing cluster or multiple computing machines that can communicate via communication connections. Therefore, the computing device 1200 can operate in a networked environment using a logical connection with one or more other servers, networked personal computers (PCs) or further general network nodes.

The input device 1250 may be one or more of a variety of input devices, such as a mouse, keyboard, tracking ball, voice-input device, and the like. The output device 1260 may be one or more of a variety of output devices, such as a display, loudspeaker, printer, and the like. By means of the communication unit 1240, the computing device 1200 can further communicate with one or more external devices (not shown) such as the storage devices and display device, with one or more devices enabling the user to interact with the computing device 1200, or any devices (such as a network card, a modem and the like) enabling the computing device 1200 to communicate with one or more other computing devices, if required. Such communication can be performed via input/output (I/O) interfaces (not shown).

In some embodiments, instead of being integrated in a single device, some or all components of the computing device 1200 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1200 may be used to implement video encoding/decoding in embodiments of the present disclosure. The memory 1220 may include one or more video coding modules 1225 having one or more program instructions. These modules are accessible and executable by the processing unit 1210 to perform the functionalities of the various embodiments described herein.

In the example embodiments of performing video encoding, the input device 1250 may receive video data as an input 1270 to be encoded. The video data may be processed, for example, by the video coding module 1225, to generate an encoded bitstream. The encoded bitstream may be provided via the output device 1260 as an output 1280.

In the example embodiments of performing video decoding, the input device 1250 may receive an encoded bitstream as the input 1270. The encoded bitstream may be processed, for example, by the video coding module 1225, to generate decoded video data. The decoded video data may be provided via the output device 1260 as the output 1280.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, a plurality of motion vector prediction (MVP) candidates of the current video block;
determining a candidate list of the current video block by applying a plurality of pruning processes to the plurality of MVP candidates; and
performing the conversion based on the candidate list.

2. The method of claim 1, wherein the plurality of pruning processes comprises a first pass pruning process, and determining the candidate list comprises:
determining a group of MVP candidates based on the plurality of MVP candidates;
applying the first pass pruning process to the group of MVP candidates; and
determining the candidate list based on the pruned group of MVP candidates,
wherein the group comprises at least one of: a single group of MVP candidates of a single candidate category, or a joint group of MVP candidates of a plurality of candidate categories, and/or
wherein the method further comprises: sorting at least a partial of the pruned group of MVP candidates, wherein the sorting is based on an adaptive reordering merge candidates (ARMC) process.

3. The method of claim 1, wherein the plurality of pruning processes comprises a second pass pruning process, and determining the candidate list comprises:
determining a plurality of groups of MVP candidates based on the plurality of MVP candidates;
determining at least one hybrid group of MVP candidate based on the plurality of groups;
applying the second pass pruning process to the at least one hybrid group of MVP candidates; and
determining the candidate list based on the at least one pruned hybrid group of MVP candidates, wherein the method further comprises: sorting the at least one pruned hybrid group of MVP candidates, or wherein the at least one pruned hybrid group of MVP candidates is not sorted.

4. The method of claim 1, wherein the plurality of pruning processes comprises a third pass pruning process, and determining the candidate list comprises:
determining a plurality of groups of MVP candidates based on the plurality of MVP candidates;
determining at least one hybrid group of MVP candidates based on the plurality of groups;
updating the at least one hybrid group by adding at least one MVP candidate into the at least one hybrid group;
applying the third pass pruning process to the at least one hybrid group; and
determining the candidate list based on the at least one pruned hybrid group of MVP candidates, wherein the plurality of pruning processes comprises a fourth pass pruning process, and determining the candidate list based on the at least one pruned hybrid group comprises:
applying the fourth pass pruning process to the at least one pruned hybrid group; and
determining the candidate list based on the at least one pruned hybrid group of MVP candidates.

5. The method of claim 1, wherein the plurality of pruning processes is utilized separately or in combination.

6. The method of claim 1, wherein applying the plurality of pruning processes to the plurality of MVP candidates comprises:
applying at least a partial of plurality of pruning processes to the plurality of MVP candidates based on an order of the plurality of pruning processes,
wherein the order of the plurality of pruning processes comprises one of:
a first order of a first pass pruning process, a second pass pruning process, and a fourth pass pruning process,
a second order of a first pass pruning process, a second pass pruning process, and a third pass pruning process,
a third order of a first pass pruning process, and a second pass pruning process,
a fourth order of a first pass pruning process, and a third pass pruning process,
a fifth order of a first pass pruning process, a third pass pruning process, and a fourth pass pruning process,
a sixth order of a first pass pruning process, and a fourth pass pruning process, or
a seventh order of a first pass pruning process, a fourth pass pruning process, a second pass pruning process, a third pass pruning process, and a fourth pass pruning process,
wherein the order of the plurality of pruning processes is changed during the conversion, and/or
wherein a first pruning process of the plurality of pruning processes is performed for a plurality of times during the conversion.

7. The method of claim 1, wherein applying the plurality of pruning processes to the plurality of MVP candidates comprises:
applying the plurality of pruning processes to the plurality of MVP candidates based on a plurality of thresholds,
wherein a threshold of the plurality of thresholds is used to determine whether an MVP candidate of the plurality of MVP candidates is to be added into the candidate list,
wherein the plurality of thresholds for the plurality of pruning processes is the same or different,
wherein a first threshold associated with a pruning process of the plurality of pruning processes is a constant, wherein the first threshold is determined from the bitstream, or
wherein the first threshold is determined based on coding information of the current video block, wherein the coding information of the current video block comprises at least one of: quantization parameter (QP) of the current video block, or a parameter associated with a rate distortion optimization (RDO) process, and/or
wherein a plurality of candidate threshold values is stored in a data structure, and the first threshold is determined by: determining an index of the first threshold from the bitstream; and obtaining the first threshold from the data structure based on the index, wherein the data structure comprises a look up table.

8. The method of claim 1, wherein determining the candidate list comprises:
determining at least one group of candidates based on the plurality of MVP candidates, a group of candidates comprising MVP candidates associated with at least one candidate category;
determining a hybrid group of candidates based on the at least one group;
sorting the hybrid group of candidates;
updating the sorted hybrid group by adding at least one candidate into the sorted hybrid group; and
determining the candidate list by applying a last round pruning to the updated hybrid group of candidates,
wherein the at least one candidate category comprises at least one of: an adjacent MVP candidate category, a non-adjacent MVP candidate category, a history-based MVP (HMVP) candidate category, a pairwise MVP candidate category, or a constructed MVP candidate category, and/or
wherein the number of candidates in the at least one group is less than or equal to a threshold number, wherein the threshold is a constant or is determined during the conversion, or wherein the threshold number for each of the at least one group is different.

9. The method of claim 8, wherein the at least one group comprises a single group, and determining the single group comprises: adding the plurality of MVP candidates into the single group based on a predefined order of candidate category, wherein the number of candidates associated with a candidate category is less than or equal to a threshold number, the threshold number being a constant or being determined during the conversion, or
wherein at least one pruning process is applied to the at least one group of candidates, or at least one pruning process is not applied to the at least one group of candidates,
wherein the at least one pruning process is performed within the at least one group, or wherein the at least one pruning process is performed among the at least one group, and/or
wherein at least one pruning threshold for the at least one group is the same or different, and/or
wherein if the at least one group comprises a single group, the hybrid group is the single group.

10. The method of claim 8, wherein the at least one group comprises a plurality of groups without being applied a first pass pruning process, and determining the hybrid group comprises: applying a second pass pruning process during a merging process for merging the plurality of groups into the hybrid group, or
wherein the at least one group comprises a plurality of groups being applied a first pass pruning process, and determining the hybrid group comprises: merging the plurality of groups into the hybrid group without applying a second pass pruning process, and/or
wherein the hybrid group of candidates is sorted based on at least one of: adaptive reordering merge candidates (ARMC), or a further metric.

11. The method of claim 8, further comprising:
refining at least a partial of the hybrid group based on at least one of: template matching or bilateral matching before or after sorting the hybrid group.

12. The method of claim 8, wherein a zero MVP in the hybrid group is placed at an end of the sorted hybrid group, and/or
wherein the at least one candidate comprises a constructed candidate, wherein the updated hybrid group of candidates is sorted, and/or
wherein the constructed candidate is generated based on the sorted hybrid group, and/or
wherein the constructed candidate comprises a pairwise candidate, and/or
wherein a pruning process is applied to the updated hybrid group.

13. The method of claim 8, wherein applying a last round pruning to the updated hybrid group of candidates comprises:
determining a plurality of template matching costs for candidates in the updated hybrid group of candidates; and
selecting a first candidate from the updated hybrid group and determining whether to discard the first candidate by:
determining a minimum cost difference between the first candidate in the updated hybrid group and remaining candidates in the updated hybrid group; and
in accordance with a determination that the minimum cost difference is smaller than a threshold, discard the first candidate from the updated hybrid group; and
selecting a second candidate from the updated hybrid group and determining whether to discard the second candidate.

14. The method of claim 13, wherein the second candidate is in a position where a cost difference relative to a candidate in the MVP candidate list is larger than the threshold, and/or
wherein the selecting the second candidate and determining whether to discard the second candidate is stopped after a predefined number of iterations, or after the number of candidates in the MVP candidate list reaching a predefined number, and/or
wherein the threshold is determined based on coding information of the current video block, wherein the coding information of the current video block comprises at least one of: a quantization parameter (QP) of the current video block, or a parameter associated with a rate distortion optimization (RDO) process.

15. The method of claim 1, wherein the method is applied to a first candidate before the first candidate being added into the candidate list, or applied to a second candidate after the second candidate being added into the candidate list.

16. The method of claim 1, wherein the conversion includes encoding the current video block into the bitstream.

17. The method of claim 1, wherein the conversion includes decoding the current video block from the bitstream.

18. An apparatus for video processing comprising a processor and a non-transitory memory with instructions thereon, wherein the instructions upon execution by the processor, cause the processor to perform a method comprising:
determining, for a conversion between a current video block of a video and a bitstream of the video, a plurality of motion vector prediction (MVP) candidates of the current video block;
determining a candidate list of the current video block by applying a plurality of pruning processes to the plurality of MVP candidates; and
performing the conversion based on the candidate list.

19. A non-transitory computer-readable storage medium storing instructions that cause a processor to perform a method comprising:
determining, for a conversion between a current video block of a video and a bitstream of the video, a plurality of motion vector prediction (MVP) candidates of the current video block;
determining a candidate list of the current video block by applying a plurality of pruning processes to the plurality of MVP candidates; and
performing the conversion based on the candidate list.

20. A non-transitory computer-readable recording medium storing a bitstream of a video which is generated by a method performed by an apparatus for video processing, wherein the method comprises:
determining a plurality of motion vector prediction (MVP) candidates of a current video block of the video;
determining a candidate list of the current video block by applying a plurality of pruning processes to the plurality of MVP candidates; and
generating the bitstream based on the candidate list.
